(19) United States
(12) Patent Application Publication
(10) Pub. No.: US 2025/0311081 A1
(43) Pub. Date: Oct. 2, 2025

(54) PLASMA JET

(71) Applicant: The University of Toledo, Toledo, OH (US)

(72) Inventors: Abbas Semnani, Toledo, OH (US); Muhammad Rizwan Akram, Toledo, OH (US)

(73) Assignee: The University of Toledo, Toledo, OH (US)

(21) Appl. No.: 18/624,713

(22) Filed: Apr. 2, 2024

(51) Int. Cl. H05H 1/24

(52) U.S. Cl. CPC H05H 1/2443; H05H 1/2418; H05H 1/2431

(57) ABSTRACT

Plasma jet assemblies utilizing dielectric substrates, and methods of making the same and using the same, are described.

### STATEMENT REGARDING FEDERALLY SPONSORED RESEARCH

This invention was made with government support under Grant Number 2102100 awarded by The National Science Foundation. The government has certain rights in this invention.

### RELATED APPLICATIONS

None.

### BACKGROUND

Cold plasma is a critical technology in many application fields, including microelectronic fabrication, plasma medicine, flow control, lighting, propulsion, and sterilization. However, generating stable plasma is not a trivial task as energy-hungry machines are often required. Currently, igniting and sustaining plasma is usually performed by using either high-voltage pulses (e.g., 100s of V to kV) or high-power radio frequency (RF) sources (e.g., 10s of W). Therefore, even though low-power plasma with effective surface power density on the order of 0.1 to 1 W/cm² is sufficient for many applications, including some medical ones, most current plasma sources are bulky and expensive units as they are inefficient in transferring energy to the plasma. Hence, efficient plasma with low power consumption would impact a wide range of applications such as plasma medicine, food and water decontamination, lighting, and reconfigurable RF electronics.

Although DC, pulse, and RF plasmas have been extensively explored, there is no comprehensive understanding of microwave plasma. This is despite the fact that microwave plasma occurs in the α-discharge regime with an extremely low sheath voltage drop, ensuring that the ignited plasma is stable with no electrode erosion as an important lifetime issue. Also, higher degrees of ionization and dissociation, higher densities of electrons and reactive species, lower heavy particle temperatures, and lower breakdown voltage are other advantages of microwave plasma compared to other types of electrically excited plasma. Non-resonant microwave plasma sources, however, are also realized by employing bulky and high-power supplies. In addition, they come at a prohibitively high cost except for high-end applications. Moreover, the resulting high voltages reduce power efficiency, require cumbersome safety protocols, and create a poor environment from an electromagnetic (EM) compatibility perspective.

Due to their ability to store and enhance EM energy, it is possible to employ microwave resonant structures to achieve high-efficiency plasma with low power consumption. The main principle is to utilize resonators that can concentrate the electromagnetic fields over a small gap. In this case, even with considerably low levels of input power, the magnitude of EM fields over those critical gaps can reach the breakdown threshold, resulting in gas breakdown and plasma formation. Since the effective size of the gap decreases after plasma formation, the required amount of power for sustaining plasma is usually even less. Before plasma ignition, the unloaded resonator produces strong fields necessary for gas breakdown. The higher the quality factor of the resonator, the higher the field enhancement. After ignition, however, the plasma impedance interacts with the resonator, quenching the resonator's quality factor. Thus, resonant structures also operate as so-called “ballasts” to avoid plasma instability, such as the glow-to-arc transition and streamer formation.

Different microwave resonant structures implemented using various technologies have been successfully examined for low-power plasma creation. However, (1) most of them do not operate in atmospheric pressure, which makes them difficult to be implemented in many practical scenarios, (2) the ignited plasma region is typically confined to a minimal volume and, hence, not optimal for many applications, and (3) it is impractical in most of the cases to scale up the resonant designs to larger effective areas.

In sum, plasma jets have many applications, such as in the biomedical field, or for plasma propulsion or plasma processing. Most plasma jets employ either RF or pulse excitation. However, these devices are typically not efficient, and are energy hungry, bulky, heavy, and expensive. Also, because of the high power/voltage involved, safety is a big concern. There are other microwave plasma jets, in both resonant and non-resonant modes, but still typically require high power consumption. Accordingly, there remains a need in the art for new and improved plasma jets.

### SUMMARY

Provided is a plasma jet assembly comprising a dielectric substrate having a first surface and a second surface opposite the first surface; a first metallic layer disposed on the first surface of the dielectric substrate; a second metallic layer disposed on the second surface of the dielectric substrate; a first conductor extending through the dielectric substrate from the first metallic layer to the second metallic layer; a second conductor spaced apart from the first conductor, the second conductor extending through the dielectric substrate from the first metallic layer to the second metallic layer; a recess formed in the first metallic layer between the first conductor and the second conductor; the second metallic layer having a means for coupling electromagnetic radiation to the dielectric substrate between the first conductor and the second conductor; and a jet passageway formed through the first metallic layer and the first surface of the dielectric substrate.

In certain embodiments, at least one of the first conductor and the second conductor includes a via hole formed through the dielectric substrate.

In certain embodiments, at least one of the first conductor and the second conductor includes a metallic member formed through the dielectric substrate.

In certain embodiments, the means for coupling electromagnetic radiation includes a substrate channel formed in the second metallic layer.

In certain embodiments, the plasma jet assembly further comprises a feeding board having a first side and a second side, the first side having a feeding board channel corresponding to the substrate channel, and the second side having a planar transmission line configured to feed electromagnetic energy to the dielectric substrate through substrate channel and the feeding board channel, wherein the second surface of the dielectric substrate is disposed over the first side of the feeding board so that the substrate channel and the feeding board channel align.

In certain embodiments, the plasma jet assembly further comprises a first capacitor and a second capacitor disposed over the first surface of the dielectric substrate, the first capacitor is adjacent to an edge of the recess, and the second capacitor is adjacent to an opposite edge of the recess.

In certain embodiments, the jet passageway is a circular hole.

In certain embodiments, the jet passageway is a rectangular slot formed within the recess. In particular embodiments, the means for coupling electromagnetic radiation includes a substrate channel formed from the second metallic layer towards the first metallic layer.

Further provided is a plasma jet assembly comprising a dielectric substrate having a first surface and a second surface opposite the first surface; a first metallic layer disposed on the first surface of the dielectric substrate; a second metallic layer disposed on the second surface of the dielectric substrate; a first conductor extending through the dielectric substrate from the first metallic layer to the second metallic layer; a second conductor spaced apart from the first conductor, the second conductor extending through the dielectric substrate from the first metallic layer to the second metallic layer; a recess formed in the first metallic layer between the first conductor and the second conductor; a substrate channel formed from the second metallic layer towards the first metallic layer between the first conductor and the second conductor; and a jet passageway including a rectangular slot formed within the recess and through the first metallic layer and the first surface of the dielectric substrate.

In certain embodiments, at least one of the first conductor and the second conductor includes a via hole formed through the dielectric substrate.

In certain embodiments, at least one of the first conductor and the second conductor includes a metallic member formed through the dielectric substrate.

In certain embodiments, a feeding board has a first side and a second side, the second side having a planar transmission line configured to feed electromagnetic energy to the dielectric substrate through the substrate channel.

In certain embodiments, the plasma jet assembly further comprises a first capacitor and a second capacitor disposed over the first surface of the dielectric substrate, the first capacitor is adjacent to an edge of the recess, and the second capacitor is adjacent to an opposite edge of the recess.

Further provided is a plasma jet assembly comprising a dielectric substrate having a first surface and a second surface opposite the first surface; a first metallic layer disposed on the first surface of the dielectric substrate, a second metallic layer disposed on the second surface of the dielectric substrate, a first conductor extending through the dielectric substrate from the first metallic layer to the second metallic layer, a second conductor spaced apart from the first conductor, the second conductor extending through the dielectric substrate from the first metallic layer to the second metallic layer, a recess formed in the first metallic layer between the first conductor and the second conductor, the second metallic layer having a substrate channel between the first conductor and the second conductor, and a jet passageway formed through the first metallic layer and the first surface of the dielectric substrate; and a feeding board having a first side and a second side, the first side having a feeding board channel corresponding to the substrate channel, and the second side having a planar transmission line configured to feed electromagnetic energy to the dielectric substrate through substrate channel and the feeding board channel, wherein the second surface of the dielectric substrate is disposed over the first side of the feeding board so that the substrate channel and the feeding board channel align.

In certain embodiments, at least one of the first conductor and the second conductor includes a via hole formed through the dielectric substrate.

In certain embodiments, at least one of the first conductor and the second conductor includes a metallic member formed through the dielectric substrate.

In certain embodiments, the plasma assembly comprises a first capacitor and a second capacitor disposed over the first surface of the dielectric substrate, the first capacitor is adjacent to an edge of the recess, and the second capacitor is adjacent to an opposite edge of the recess.

In certain embodiments, the jet passageway is a circular hole.

In certain embodiments, the jet passageway is a rectangular slot formed within the recess, and wherein the substrate channel is formed from the second metallic layer towards the first metallic layer.

Further provided is a plasma jet assembly comprising a dielectric substrate configured to act as a split ring resonator and concentrate electromagnetic energy at a position adjacent to a jet passageway formed through the dielectric substrate; a source of electromagnetic energy coupled to the dielectric substrate; and a gas source configured to supply gas to the jet passageway.

In certain embodiments, the plasma jet assembly further comprises a first metallic layer disposed on a first surface of the dielectric substrate and a second metallic layer disposed on a second surface of the dielectric substrate.

In certain embodiments, the plasma jet assembly further comprises a first conductor extending through the dielectric substrate from the first metallic layer to the second metallic layer; and a second conductor spaced apart from the first conductor, the second conductor extending through the dielectric substrate from the first metallic layer to the second metallic layer.

In certain embodiments, the plasma jet assembly further comprising a first capacitor and a second capacitor disposed over a first surface of the dielectric substrate, wherein the first capacitor is adjacent to an edge of a recess formed through the first surface of the dielectric substrate, and wherein the second capacitor is adjacent to an opposite edge of the recess.

In certain embodiments, the jet passageway is a circular hole. In certain embodiments, the jet passageway is a rectangular slot.

Advantageously, a plasma jet assembly as described herein can have higher efficiency, lower energy consumption, a compact form factor, and higher safety when compared to conventional plasma jets. A plasma jet assembly as described herein can be desirably applied to a variety of different fields and technologies, such as, but not limited to, plasma medicine, food/water/agricultural decontamination, material processing, propulsion, antimicrobial treatments, reconfigurable RF electronics, and flow controls.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1A: Perspective view of a plasma jet assembly having a dielectric substrate and a feeding board according to one or more embodiments of the present disclosure.

FIG. 1B: Transparent perspective view of a plasma jet assembly shown in FIG. 1A.

FIG. 1C: Perspective view of a plasma jet assembly shown in FIG. 1A with a schematic representation of a gas source and a source of electromagnetic energy.

FIG. 2: Top plan view of the plasma jet assembly shown in FIG. 1A.

FIG. 3: Bottom plan view of the plasma jet assembly shown in FIG. 1A.

FIG. 4: Top plan view of a dielectric substrate according to one or more embodiments of the present disclosure.

FIG. 5: Bottom plan view of a dielectric substrate according to one or more embodiments of the present disclosure.

FIG. 6: Top plan view of a feeding board according to one or more embodiments of the present disclosure.

FIG. 7: Bottom plan view of the feeding board shown in FIG. 6.

FIG. 8: Photograph of a plasma jet assembly having tuning capacitors according to one or more embodiments of the present disclosure.

FIG. 9A: Perspective view of a dielectric substrate according to one or more embodiments of the present disclosure.

FIG. 9B: Transparent side elevational view of the dielectric substrate shown in FIG. 9A.

FIG. 10: Top plan view of the dielectric substrate shown in FIG. 9A.

FIG. 11: Bottom plan view of the dielectric substrate shown in FIG. 9A.

FIG. 12A: Photograph of a gas flow channel according to one or more embodiments of the present disclosure.

FIG. 12B: Photograph of the gas flow channel shown in FIG. 12A assembled into a feeding board according to one or more embodiments of the present disclosure.

FIG. 13: Schematic of an anapole device with a loop and a dielectric cylinder according to one or more embodiments of the present disclosure.

FIG. 14: Graph showing the radiated power being evaluated through numerical Cartesian multi-pole expansion, and the total power accepted by the device in red.

FIG. 15: Graph showing the simulated near electric field depicted around a non-radiating (anapole) source according to one or more embodiments of the present disclosure.

FIG. 16: Graph showing the simulated near electric field depicted around the loop without the dielectric resonator, acting as a radiating source.

FIG. 17: Graph showing extracted radiated powers computed using Cartesian multipole expansion and numerical methods for the anapole device shown in FIG. 13 with a via separation (s)=0.6 mm while the input impedance varies from 15 to 150 kΩ, depending on s.

FIG. 18: Graph showing extracted radiated powers computed using Cartesian multipole expansion and numerical methods for the anapole device shown in FIG. 13 with a via separation (s)=1.2 mm while the input impedance varies from 15 to 150 kΩ, depending on s.

FIG. 19: Graph showing electric and magnetic dipoles separately evaluated for the loop and the dielectric resonator for s=0.6 mm, where p is electric, m is magnetic, subscript t is toroidal, superscript m is metal, and d is dielectric.

FIG. 20: Graph showing electric and magnetic dipoles separately evaluated for the loop and the dielectric resonator for s=1.2 mm, where p is electric, m is magnetic, subscript t is toroidal, superscript m is metal, and d is dielectric.

FIG. 21: Top plan view of a dielectric resonator according to one or more embodiments of the present disclosure.

FIG. 22: Bottom plan view of a dielectric resonator according to one or more embodiments of the present disclosure.

FIG. 23: Top plan view of a feeding board according to one or more embodiments of the present disclosure.

FIG. 24: Bottom plan view of a feeding board according to one or more embodiments of the present disclosure.

FIG. 25: An anapole device connected to a transmitter port of a vector network analyzer (VNA) through a 50-Ω cable, with an H-field probe on top attached to the receiver port of the VNA, and configured for H_{y} measurements. The feeding board is coupled to the resonator using a slot coupling topology.

FIG. 26: Graph showing the simulated and measured reflection coefficients.

FIG. 27: Graph showing the Cartesian multipole expansion and numerical evaluation for radiated and accepted powers.

FIG. 28: Graph showing assessment of contributions from metallic and dielectric components for electric and magnetic dipoles in the anapole device.

FIG. 29: Graph showing simulated E_{z} for XY plane at a height of z=4 mm. The color bars are in dB scale.

FIG. 30: Graph showing simulated H_{y} at the XY plane at a height of z=4 mm. The color bars are in dB scale.

FIG. 31: Graph showing simulated Eₓ for the YZ plane with x=0. The color bars are in dB scale.

FIG. 32: Graph showing simulated H_{y} at the YZ plane with x=0. The color bars are in dB scale.

FIG. 33: Graph showing measured E_{z} for XY plane at a height of h=4 mm. The color bars are in dB scale.

FIG. 34: Graph showing measured H_{y} for XY plane at a height of h=4 mm. The color bars are in dB scale.

FIG. 35: Graph showing measured Eₓ for YZ plane with x=0. The color bars are in dB scale.

FIG. 36: Graph showing measured H_{y} for YZ plane with x=0. The color bars are in dB scale.

FIG. 37: Graph showing measured electric field amplitude on the vertical axis plotted against the distance (R) between transmitter and receiver on the horizontal axis, where fᵣ represents the anapole frequency.

FIG. 38: Top view of a dielectric resonator according to one or more embodiments of the present disclosure.

FIG. 39: Bottom view of the dielectric resonator shown in FIG. 38.

FIG. 40: Top view of the feeding board according to one or more embodiments of the present disclosure.

FIG. 41: Bottom view of the feeding board according to one or more embodiments of the present disclosure.

FIG. 42: Top view of a fabricated anapole plasma jet device according to one or more embodiments of the present disclosure.

FIG. 43: Bottom view of the fabricated anapole plasma jet device shown in FIG. 42.

FIG. 44: Graph showing radiation assessment for various dipoles, where ED is electric dipole, MD is magnetic dipole, EQ is electric quadruple, MQ is magnetic quadruple, and ET is electric toroidal dipole. P_{rad} and Pᵢₙ denote the simulated values of radiated and accepted power by anapole, with only the Pᵢₙ scale corresponding to the orange color.

FIG. 45: Graph showing evaluation of electric dipole strength (p) over metallic and dielectric components, where superscripts m and d correspond to metallic and dielectric parts, respectively. The polarizations are denoted by x, y, and z.

FIG. 46: Graph showing simulated and measured reflection coefficients.

FIG. 47: Enhanced electric field in the range of 10⁶ (V/m) at the gas ignition region.

FIG. 48: Experimental setup for the anapole plasma jet ignition and characterization according to one or more embodiments of the present disclosure.

FIG. 49: Images of the anapole plasma jet at various helium flow rates at a constant input power of 2.8 W.

FIG. 50: Graph showing measured reflection coefficients.

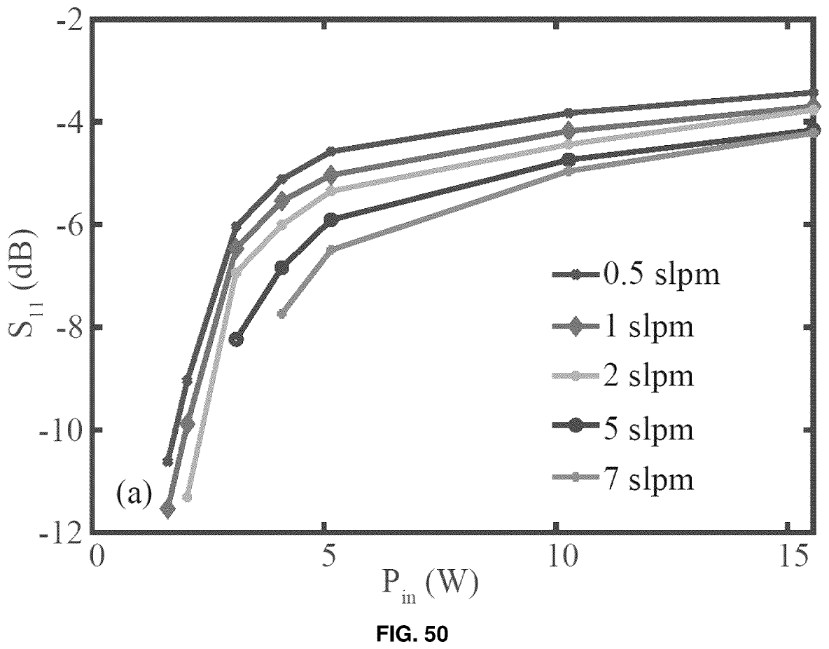

FIG. 51: Graph showing absorbed powers.

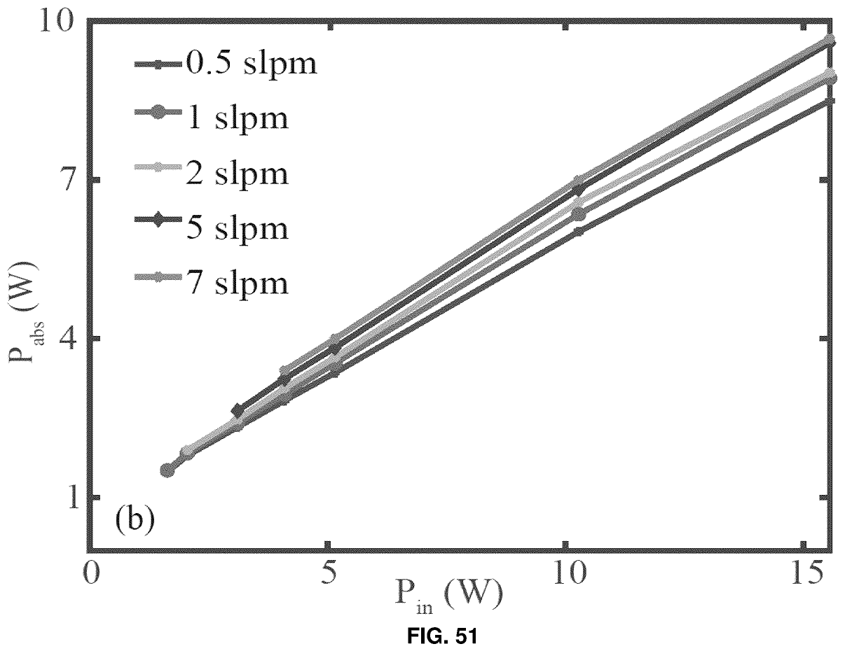

FIG. 52: Graph showing power efficiencies versus input power at various flow rates.

FIG. 53: Table showing measured gas temperature and the corresponding spectral broadenings at 5 slpm and various input powers.

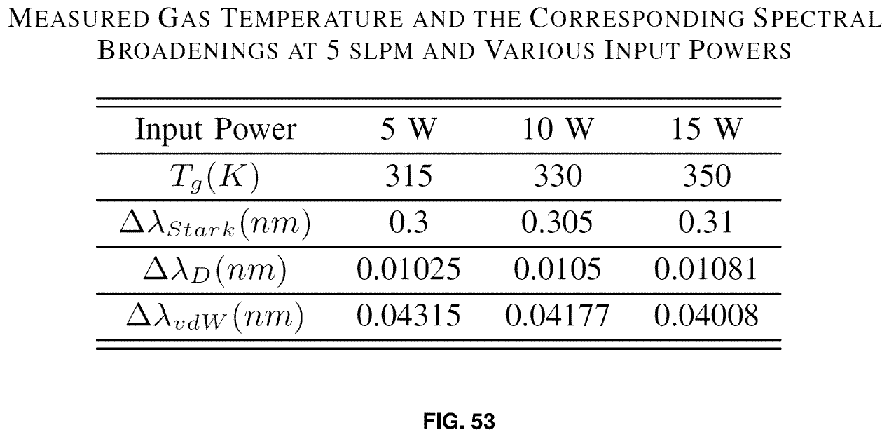

FIG. 54: Graph showing simulated and measured spectrums at 5 slpm flow rate and 15 W input power for a temperature of 350 K.

FIG. 55: Graph showing H-α line at 15 W input power and 5 slpm of helium flow rate. Δλ_{Stark} is calculated from FWHM as required to extract the jet electron density.

FIG. 56: Graph showing frequency tuning of the anapole plasma jet by employing two tuning capacitors positioned at the edges of the tapered slots.

FIG. 57: Photograph showing a top view of a fabricated plasma line dielectric resonator according to one or more embodiments of the present disclosure.

FIG. 58: Photograph showing a bottom view of the fabricated plasma line dielectric resonator shown in FIG. 57.

FIG. 59: Photograph showing a 3D printed gas flow channel according to one or more embodiments of the present disclosure.

FIG. 60: Photograph showing an enlarged view of the gas flow channel shown in FIG. 59.

FIG. 61: Photograph showing a top view of a gas flow channel and a feeding board according to one or more embodiments of the present disclosure.

FIG. 62: Photograph showing an enlarged view of the gas flow channel and the feeding board shown in FIG. 61.

FIG. 63: Photograph showing a bottom view of the gas flow channel and the feeding board shown in FIG. 61.

FIG. 64: Photograph showing a top view of an assembled anapole resonator according to one or more embodiments of the present disclosure.

FIG. 65: Photograph showing a bottom view of the assembled anapole resonator shown in FIG. 64.

FIG. 66: Photograph showing the assembled anapole resonator shown in FIG. 64 in operation.

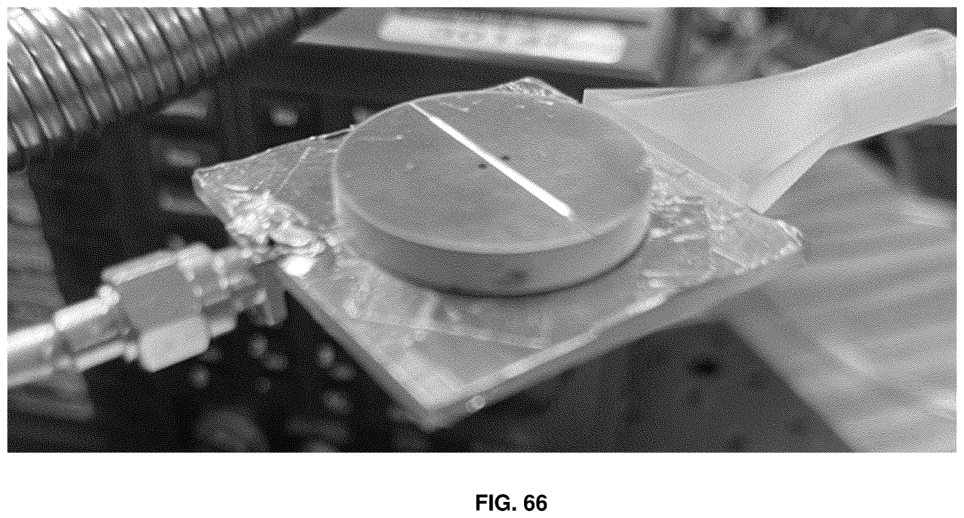

FIG. 67: Graph showing reflection response measurements.

FIG. 68: Simulation results for the electric field.

FIG. 69: Photograph showing the assembled anapole resonator shown in FIG. 64 in operation at 30 slpm and 25 W of power.

FIG. 70: Photograph showing the assembled anapole resonator shown in FIG. 64 in operation at 30 slpm and 25 W of power.

FIG. 71: Photograph showing the assembled anapole resonator shown in FIG. 64 in operation at 30 slpm and 25 W of power.

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

As used herein, the term “coupling” refers to the transfer of energy from one medium to another medium. Examples of coupling include, but are not limited to, direct coupling, resistive conduction, atmospheric plasma channel coupling, inductive coupling, capacitive coupling, evanescent wave coupling, radio waves, electromagnetic interference, and microwave power transmission.

As used herein, the terms “microwave laminate” can include substrates used for radio frequency (RF) and microwave communication systems and electronics. Generally, microwave laminates have a low dissipation factor, low levels of moisture absorption, and a low dielectric constant.

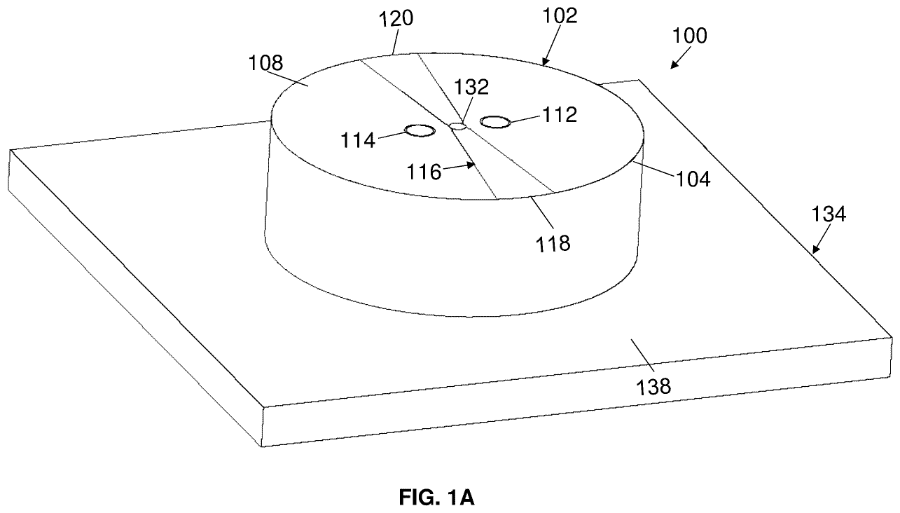

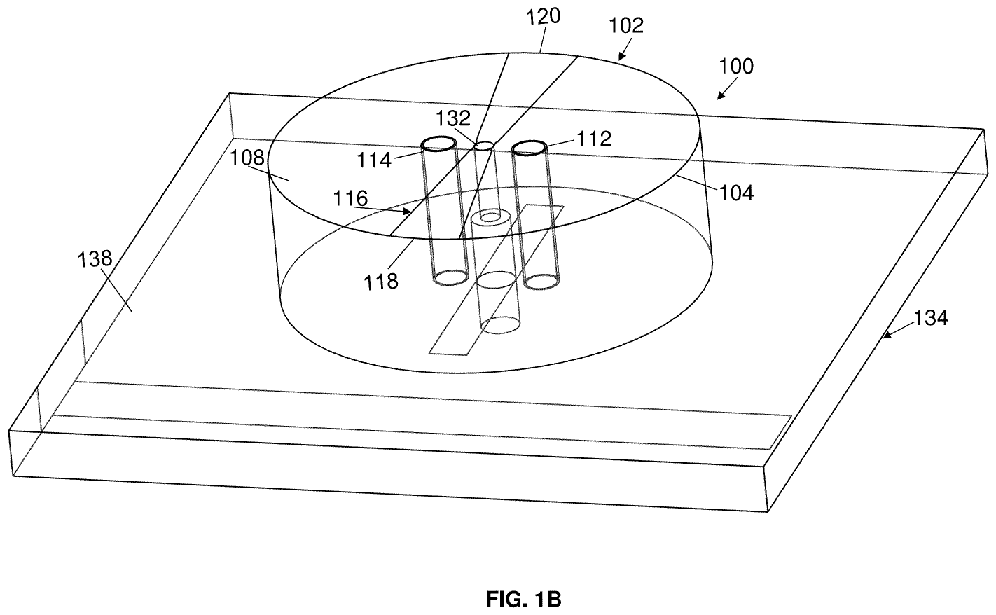

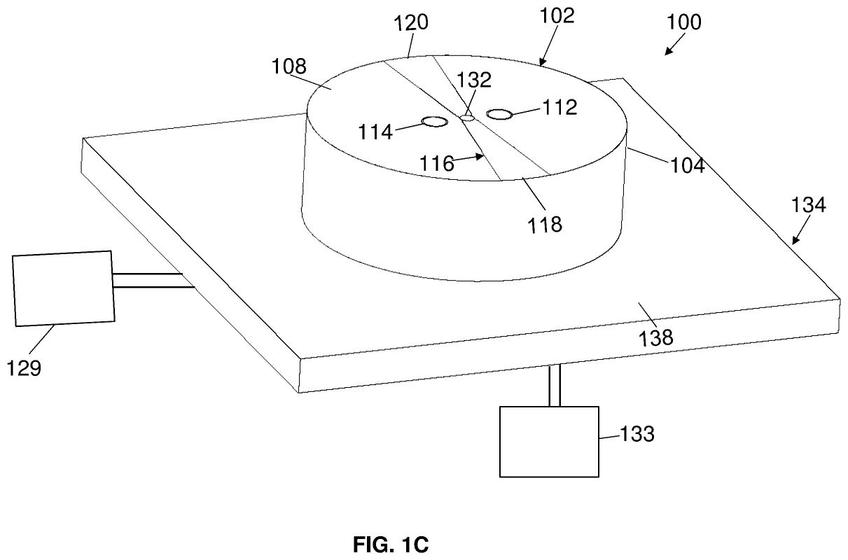

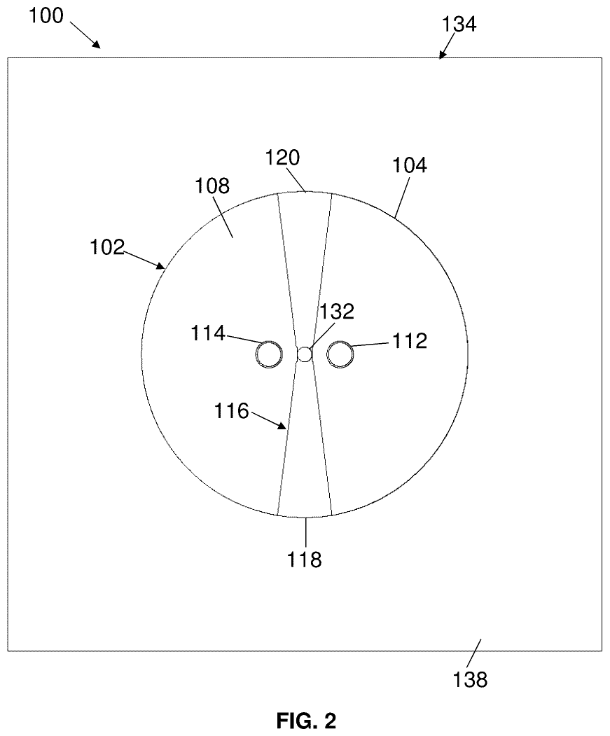

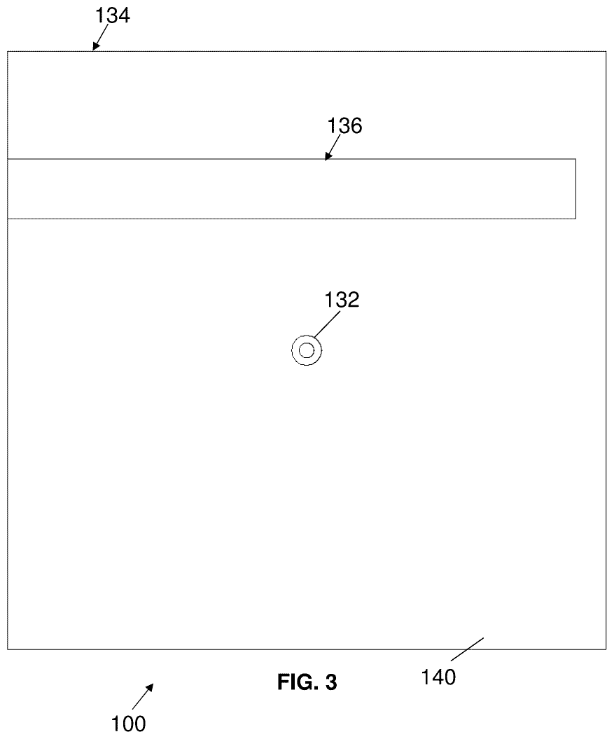

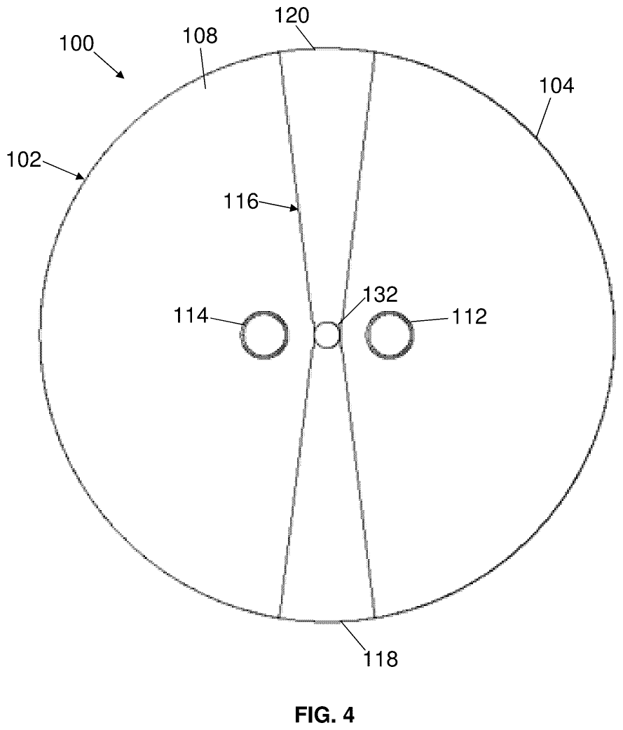

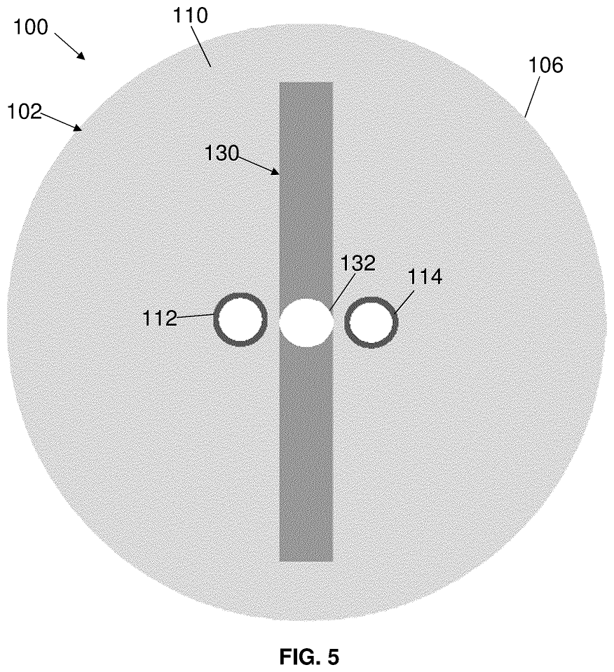

Referring now to FIGS. 1A, 1B, 1C, and 2-8, a first embodiment of a plasma jet assembly 100 is shown. With reference to FIGS. 4-5, the plasma jet assembly 100 includes a dielectric substrate 102. The dielectric substrate 102 is configured to function as a dielectric resonator, which will be discussed in further detail below. The dielectric substrate 102 has a first surface 104 and a second surface 106. In the illustrated embodiment, the dielectric substrate 102 has a cylindrical shape. Desirably, the cylindrical shape can facilitate using the dielectric substrate 102 with printed circuit board (PCB) fabrication techniques. Other shapes may be employed for the dielectric substrate 102 within the scope of this disclosure. In certain examples, the dielectric substrate 102 can have a low dielectric constant, for example, a dielectric constant in a range of from greater than zero to about 39, in a range of from about 4.33 to about 39, in a range of from about 6.5 to about 26, or about 12.85. The dielectric substrate 102 can have a dielectric loss tangent (tan δ) in a range of from about 0.63×10³ to about 5.7×10³, in a range of from about 0.95×10⁻³ to 3.8×10³, or about 1.9×10⁻³.

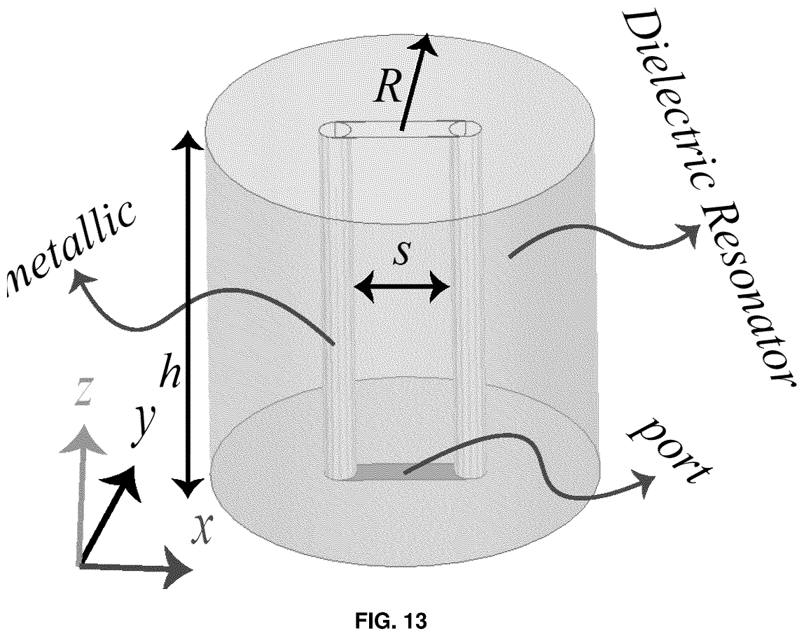

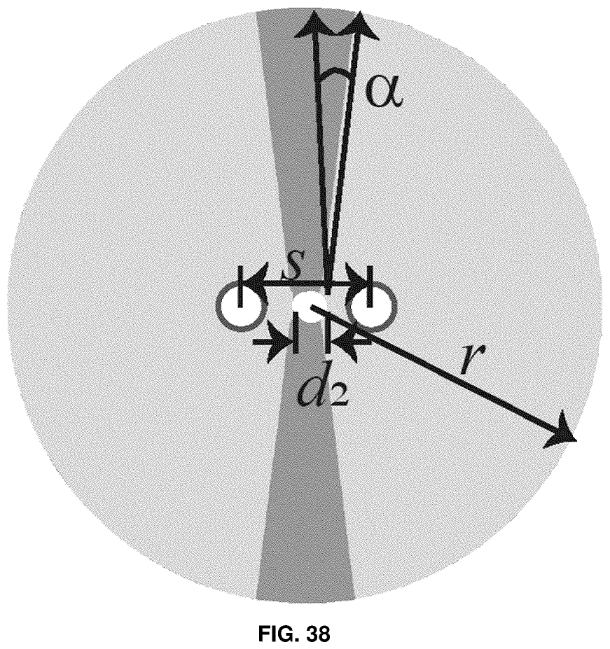

In certain examples, the dielectric substrate 102 includes one or more microwave laminates. A non-limiting example of a microwave laminate includes Rogers TMM 13i laminate. In certain examples, the dielectric substrate 102 can have a thickness h (see FIG. 13, where the “dielectric resonator” is an example of a dielectric substrate 102) in a range of from about 1.27 mm to about 11.43 mm, in a range of from about 1.90 mm to about 7.62 mm, or about 3.81 mm. In examples where the dielectric substrate 102 has a cylindrical shape, the dielectric substrate 102 can have a radius r (see FIG. 38) in a range of from about 3.66 mm to about 33 mm, in a range of from about 5.5 mm to about 22 mm, or about 11 mm.

With reference to FIG. 4, the first surface 104 of the dielectric substrate 102 can include a first metallic layer 108 formed or disposed thereon. The first metallic layer 108 can include one or more metallic elements, such as copper. In certain examples, the first metallic layer 108 has a thickness in a range of from about 11.66 μm to about 105 μm, in a range of from about 17.5 μm to about 70 μm, or about 35 μm.

Referring now to FIG. 5, the second surface 106 of the dielectric substrate 102 can include a second metallic layer 110 formed or disposed thereon. The second metallic layer 110 can include one or more metallic elements, such as copper. In certain examples, the second metallic layer 110 has a thickness in a range of from about 11.66 μm to about 105 μm, in a range of from about 17.5 μm to about 70 μm, or about 35 μm.

As shown in FIGS. 4-5, a first conductor 112 is disposed through the dielectric substrate 102 from the first metallic layer 108 to the second metallic layer 110. In certain examples, the first conductor 112 is a via hole formed from the first metallic layer 108 to the second metallic layer 110. In another example, the first conductor 112 is a metallic member, e.g., a metal rod, extending between the first metallic layer 108 to the second metallic layer 110. The first conductor 112 can have a diameter in a range of from about 0.3 mm to about 2.7 mm, in a range of from about 0.45 mm to about 1.8 mm, or about 0.9 mm.

While still referring to FIGS. 4-5, a second conductor 114 is disposed through the dielectric substrate 102 from the first metallic layer 108 to the second metallic layer 110. The second conductor 114 is spaced apart from the first conductor 112. In certain examples, the second conductor 114 is spaced apart from the first conductor 112 by a distance s (see FIG. 38) measured from a center of the first conductor 112 to a center of the second conductor 114 in a range of from about 0.4 mm to about 3.6 mm, in a range of from about 0.6 mm to about 2.4 mm, or about 1.2 mm. In certain examples, the second conductor 114 is a via hole formed from the first metallic layer 108 to the second metallic layer 110. In another example, the second conductor 114 is a metallic member, e.g., a metal rod, extending between the first metallic layer 108 to the second metallic layer 110. The second conductor 114 can have a diameter in a range of from about 0.3 mm to about 2.7 mm, in a range of from about 0.45 mm to about 1.8 mm, or about 0.9 mm. Desirably, the dielectric substrate 102 in combination with the first conductor 112 and the second conductor 114 can function as a split-ring resonator configuration.

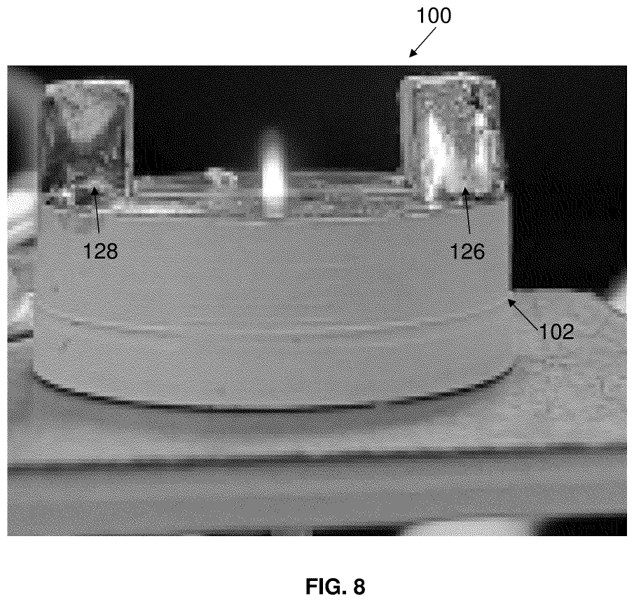

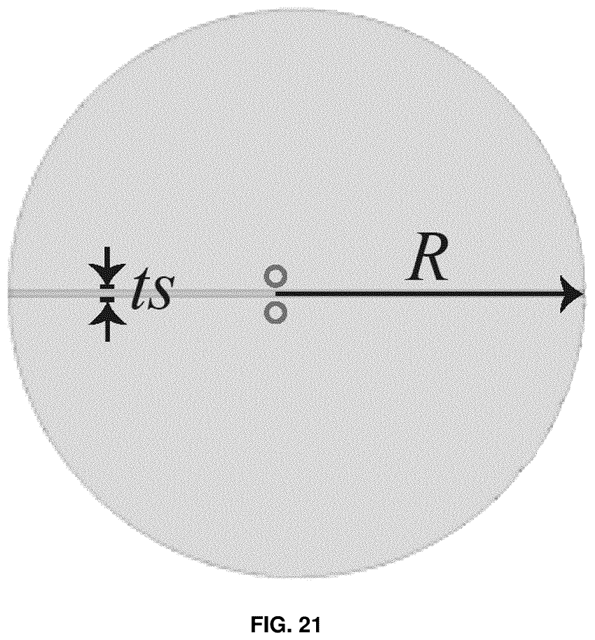

With respect to FIG. 4, a recess or etched portion 116 is formed in the first metallic layer 108 between the first conductor 112 and the second conductor 114. The recess 116 can have a first end 118 and a second end 120. The recess 116 can span from the first end 118 at an edge of the first metallic layer 108 to the second end 120 at an opposite edge of the first metallic layer 108. In certain examples, a width tₛ (see FIG. 21) of the recess 116 gradually increases from the jet passageway 132 towards each of the first end 118 and the second of the recess 116, as shown in FIG. 4. In certain examples, the recess 116 has a minimum width tₛ in a range of from about 0.1 mm to about 0.9 mm, in a range of from about 0.15 mm to about 0.6 mm, or about 0.3 mm. With reference to FIG. 8, the plasma jet assembly 100 can include one or more tuning capacitors. For example, the plasma jet assembly 100 can include a first capacitor 126 and a second capacitor 128 disposed on the first metallic layer 108. The first capacitor 126 can be disposed adjacent to the first end 118 of the recess 116 and the second capacitor 128 can be disposed adjacent to the second end 120 of the recess 116. Desirably, the first capacitor 126 and the second capacitor 128 being positioned at the first end 118 of the recess 116 and the second end 120 of the recess 116, respectively, facilitates tunable operation with a broad frequency range, spanning from about 1.6 GHz to about 2.5 GHz. Non-limiting examples of capacitors includes capacitors having a capacitance within a range of from about 0.1 pF to about 0.23 pF, in a range of from about 0.15 pF to about 1.4 pF, or in range of about 0.3 pF to about 0.7 pF.

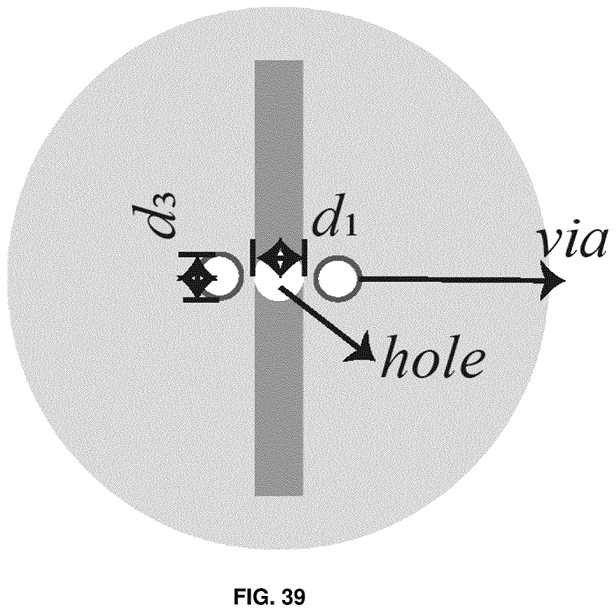

With reference to FIG. 5, the second metallic layer 110 includes a means for coupling electromagnetic radiation to the dielectric substrate 102 between the first conductor 112 and the second conductor 114. Examples of coupling include, but are not limited to, direct coupling, resistive conduction, atmospheric plasma channel coupling, inductive coupling, capacitive coupling, evanescent wave coupling, radio waves, electromagnetic interference, and microwave power transmission. The means for coupling electromagnetic radiation can also include a RF connector in communication with a source of electromagnetic energy, such as a signal generator 129 (see FIG. 1C). In certain examples, the means for coupling electromagnetic radiation includes a substrate channel 130 formed in the second metallic layer 110. The substrate channel 130 can have a width d₁ (see FIG. 39) in a range of from about 0.33 mm to about 3 mm, in a range of from about 0.5 mm to about 2 mm, or about 1 mm. The substrate channel 130 can effectively couple electromagnetic radiation to the dielectric substrate 102.

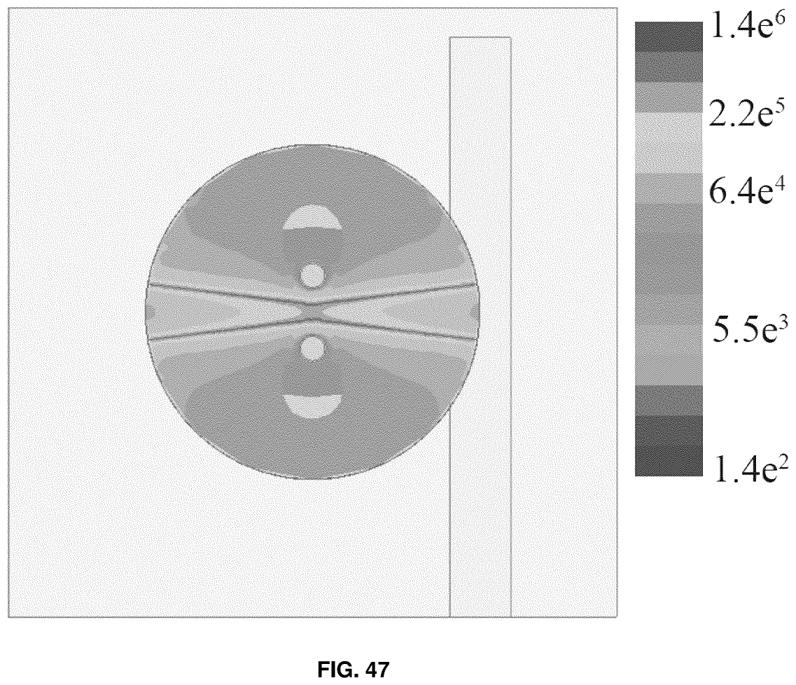

Referring now to FIGS. 1C, 4, a jet passageway 132 is formed through the first metallic layer 108 and the first surface 104 of the dielectric substrate 102. The jet passageway 132 can be in fluid communication with a gas source 133. The jet passageway 132 is configured to be a conduit for gas injection and passage through the dielectric substrate 102, and the jet passageway 132 is configured to emit the gas out of the first metallic layer 108, which may subsequently ignite into a plasma. The jet passageway 132 can be positioned substantially central in the first metallic layer 108. Desirably, this can ensure the gas flows through a sufficiently strong electric field for facilitating plasma ignition, as illustrated in FIG. 47. In certain examples, the jet passageway 132 is formed through the dielectric substrate 102 from the first metallic layer 108 to the second metallic layer 110 as shown in FIGS. 4-5. The jet passageway 132 can have a plasma jet opening on the first metallic layer 108 configured to provide an exit for the gas, which ignites to form a plasma.

In the illustrated example in FIG. 4, the jet passageway 132 is a circular hole. However, other shapes may also be employed within the scope of this disclosure. In certain examples, the jet passageway 132 has a diameter in a range of from about 0.16 mm to about 1.5 mm, in a range of from about 0.25 mm to about 1 mm, or about 0.5 mm. In certain examples, the jet passageway 132 has a maximum diameter of 1 mm and is tapered down to a diameter of 0.5 at the first metallic layer 108. In certain examples, a tube is disposed at least partially through the jet passageway 132. The tube can act as the conduit for gas injection. The tube can be in fluid communication with the jet passageway 132 and a gas source. However, a tube is not necessary.

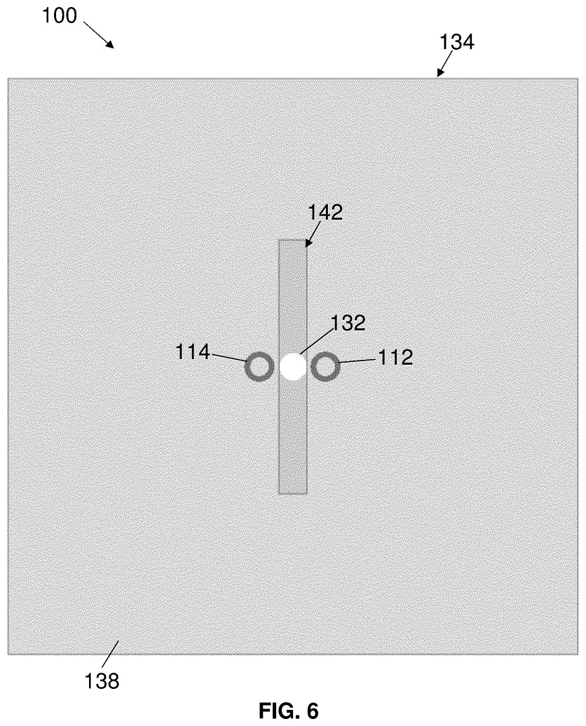

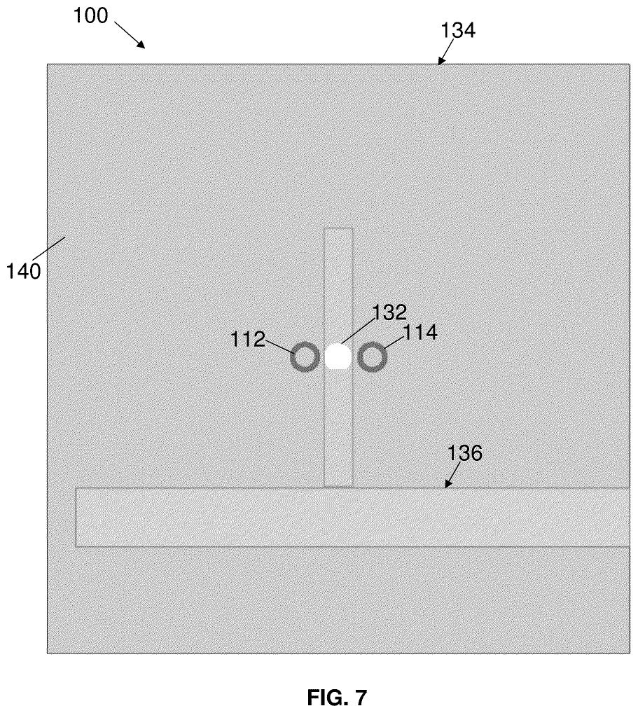

With respect to FIGS. 6-7, the plasma jet assembly 100 can further comprise a feeding board 134. The feeding board 134 can be configured to facilitate providing gas and electromagnetic energy to the dielectric substrate 102. The feeding board 134 can have a low dielectric constant, for example, a dielectric constant in a range of from greater than zero to about 18, in a range of from about 2 to about 18, in a range of from about 3 to about 12, or about 6. The feeding board 134 can have a dielectric loss tangent tan δ in a range of from about 0.76×10³ to about 6.9×10⁻³, in a range of from about 1.15×10⁻³ to 4.6×10³, or about 1.9×10³. In certain examples, the feeding board 134 includes one or more microwave laminates. A non-limiting example of a microwave laminate includes Rogers TMM 6 laminate.

Referring now to FIG. 7, the feeding board 134 can include a planar transmission line 136 configured to feed electromagnetic energy from the signal generator 129 to the dielectric substrate 102. Non-limiting examples of the planar transmission lines include striplines, microstrips, suspended striplines, and coplanar waveguides. In certain examples, the planer transmission line is a 50-Ω microstrip line. The planar transmission line 136 can be in communication with the signal generator 129 by a radio frequency (RF) connector. A non-limiting example of the RF connector is a subminiature version A (SMA) connector.

With reference to FIGS. 6-7, the feeding board 134 has a first side 138 and a second side 140. As shown in FIG. 6, the first side 138 can include a feeding board channel 142. The feeding board channel 142 can substantially correspond to the substrate channel 130, e.g., have substantially the same dimensions. However, this correspondence is not strictly necessary. The feeding board channel 142 can have a width in a range of from about 0.33 mm to about 3 mm, in a range of from about 0.5 mm to about 2 mm, or about 1 mm. The feeding board channel 142 can have a length of about 3 mm to about 27 mm, in a range of from about 4.5 to about 18 mm, or about 8.83 mm.

It should be appreciated that the positioning of the planar transmission line 136 and the size and shape of the substrate channel 130 can be varied for impedance matching purposes. In certain examples, the second side 140 of the feeding board 134 can include the planar transmission line 136 in communication with a RF connector. The planar transmission line 136 can be offset from a center of the feeding board 134 by a distance in a range of from about 1.76 mm to about 15.9 mm, in a range of from about 2.65 mm to about 10.6 mm, or about 5.3 mm.

In examples where the feeding board 134 is assembled with the dielectric substrate 102, the jet passageway 132, the first conductor 112, and the second conductor 114 can be formed from the first metallic layer 108 of the dielectric substrate 102 to the second side 140 of the feeding board 134. In certain examples, when the feeding board 134 is assembled with the dielectric substrate 102, the first conductor 112 and the second conductor 114 can be metal members or via holes with metal members extending therethrough. The second metallic layer 110 of the dielectric substrate 102 can be affixed to the first side 138 of the feeding board 134 by epoxy, e.g., silver epoxy. However, other methods of affixing the second metallic layer 110 to the first side 138 are possible and encompassed within the scope of the present disclosure.

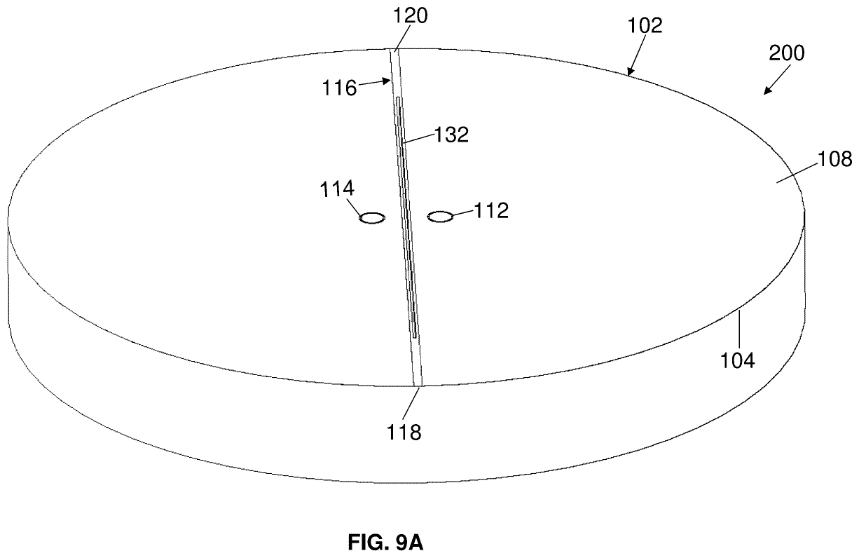

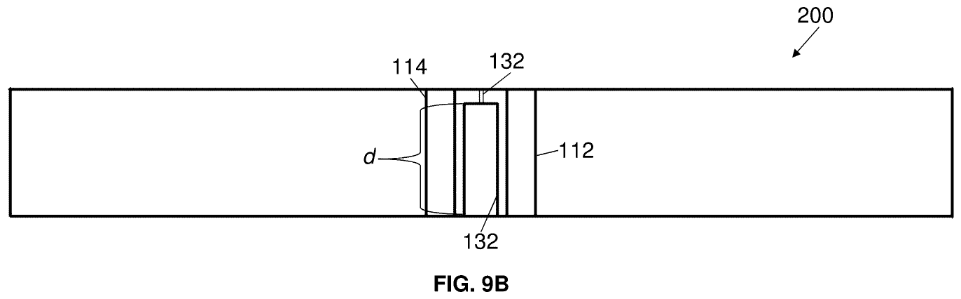

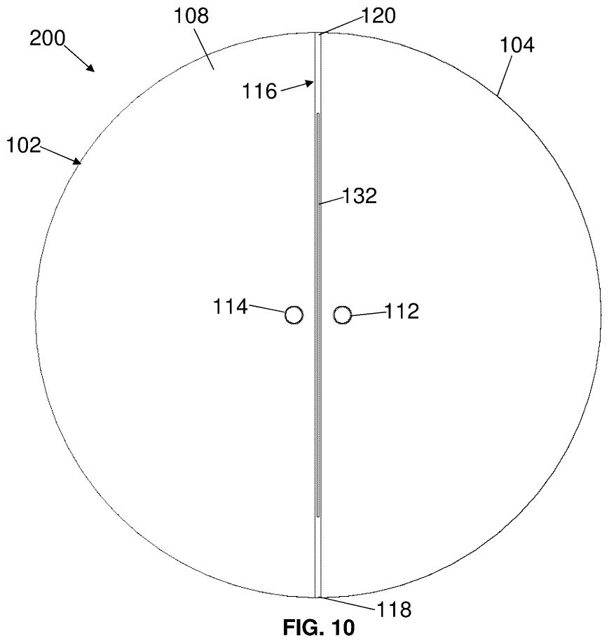

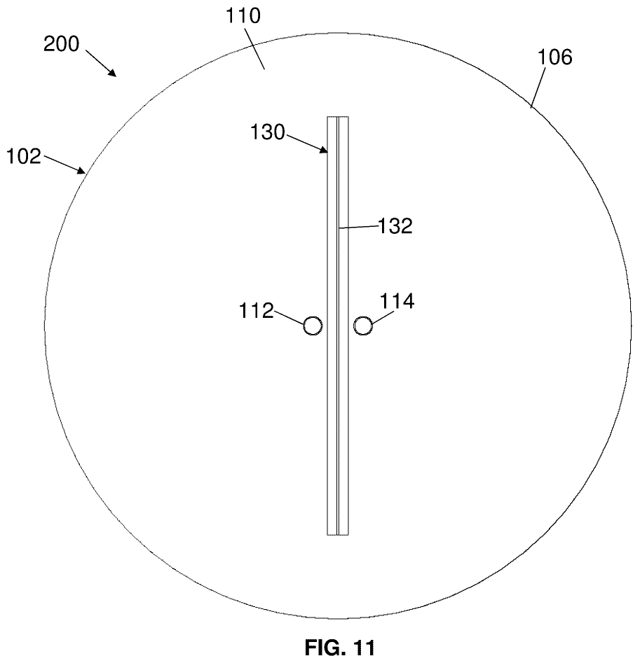

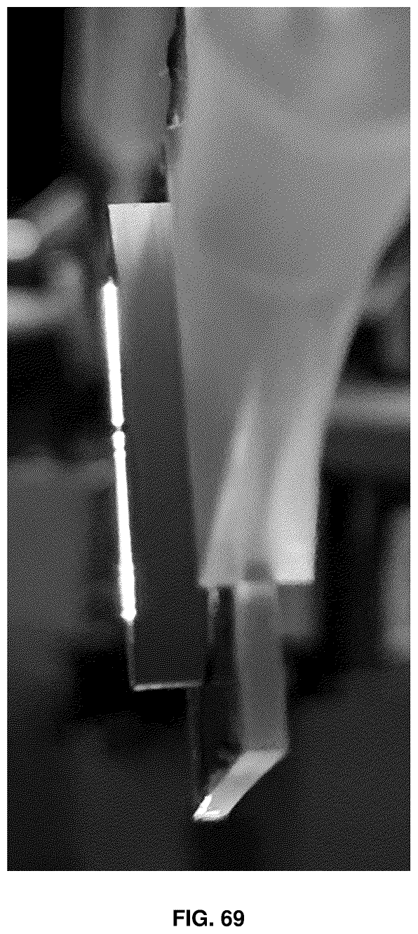

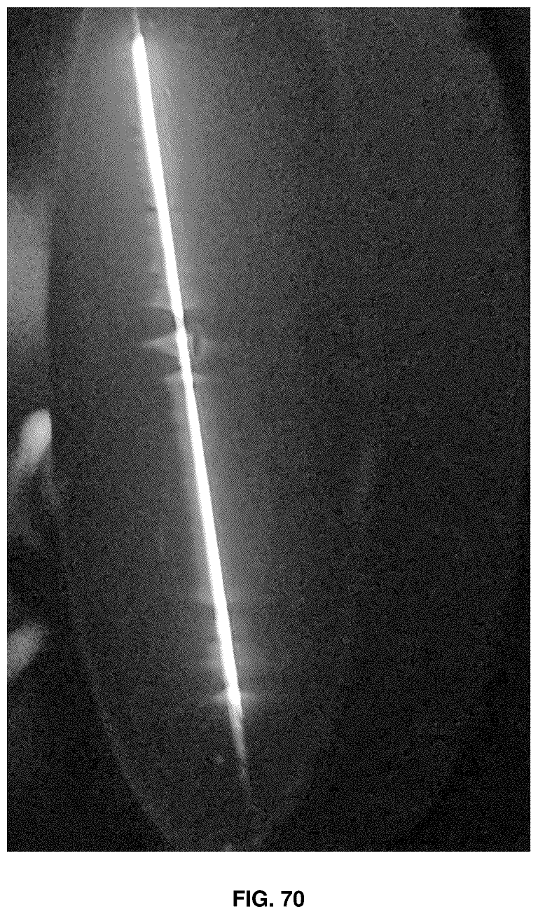

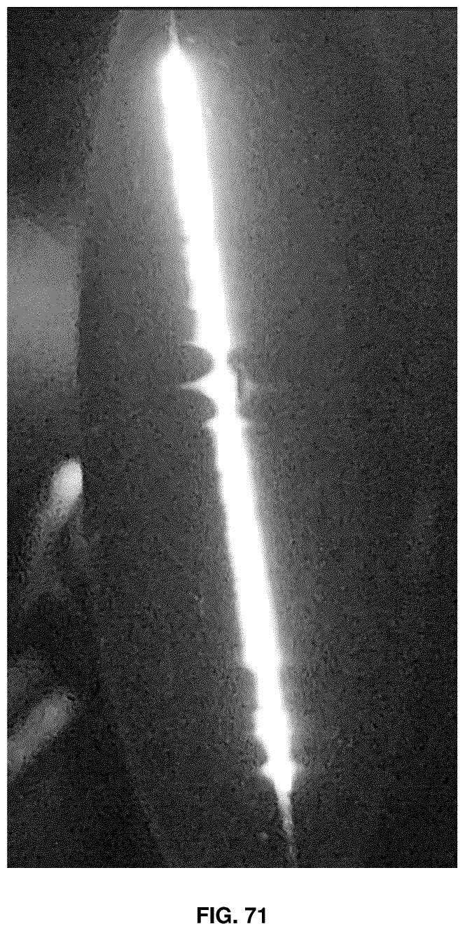

With reference to FIGS. 9A, 9B, 10-11, 12A, 12B, a second embodiment of the plasma jet assembly 200 is provided herein. In this embodiment, the plasma jet assembly 200 can be configured to emit a line-based plasma jet, as shown in FIGS. 69-71. For example, the jet passageway 132 can be a rectangular slot formed within the recess 116. The substrate channel 130 can be formed from the second metallic layer 110 towards the first metallic layer 108. The substrate channel 130 can have a width in a range of from about 0.33 mm to about 3 mm, in a range of from about 0.5 mm to about 2 mm, or about 1 mm. The substrate channel 130 can have a length in a range of from about 6.66 mm to about 60 mm, in a range of from about 10 mm to about 40 mm, or about 20 mm. The substrate channel 130 can have a depth d (e.g., FIG. 9B) from the second metallic layer 110 in a range of from about 1 mm to about 9 mm, in a range of from about 1.5 mm to about 6 mm, or about 3 mm.

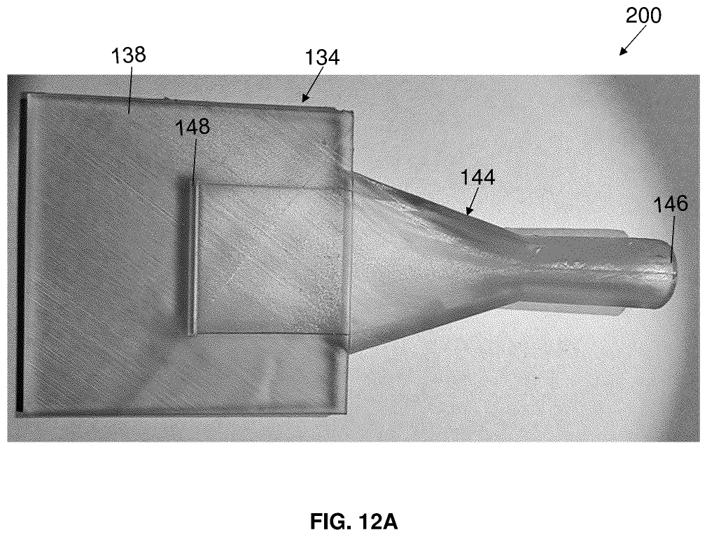

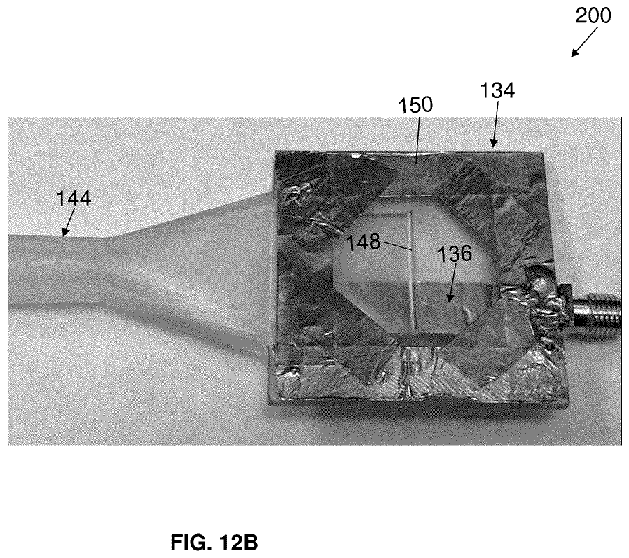

With respect to FIGS. 12A, 12B, the feeding board 134 can include a gas flow channel 144 having a gas inlet 146 and a gas outlet 148. The gas inlet 146 can be in fluid communication with a gas source. The gas outlet 148 can be in fluid communication with the jet passageway 132 of the dielectric substrate 102. In the illustrated embodiment, the gas inlet 146 can be a circular inlet. The circular inlet can have a diameter in a range of from about 2 mm to about 18 mm, in a range of from about 3 mm to about 12 mm, or about 6 mm. In the illustrated embodiment, the gas outlet 148 is a rectangular slot. Desirably, this can facilitate the plasma jet assembly 200 emitting a line-based jet of plasma.

The gas outlet 148 can have a length in a range of from about 6.66 mm to about 60, in range of about 10 mm to about 40 mm, or about 20 mm. The gas flow channel 144 can be composed of high resistance materials, for example, high temperature resistance resin. In certain examples, the gas flow channel 144 is composed of Formlabs High Temp V2 Resin. The first side 138 of the feeding board 134 can be at least partially covered by a feeding board metallic layer 150. The feeding board metallic layer 150 can include one or more metallic elements, such as copper. In certain examples, the feeding board metallic layer 150 can be copper tape, as shown in FIG. 12B.

A method of using the plasma jet assembly 100 can include connecting the plasma jet assembly 100 to the signal generator 129 and the gas source 133; activating the signal generator 129 and the gas source 133 to produce a jet of plasma out of the jet passageway 132 on the first metallic layer 108. The method can further comprise varying the capacitance for the first capacitor 126 and the second capacitor 128 to tune the frequency of the electromagnetic energy.

The plasma jet assembly 100 can be made available via a kit. A non-limiting example of such a kit includes two or more the dielectric substrate 102, a feeding board 134, a gas source 133, and a signal generator 129, housed in two or more containers packaged in a combined configuration. Instructions for assembling a plasma jet using the components of the kit may be recorded on a suitable recording medium. For example, the instructions may be present in the kit as a package insert or in the labeling of the container of the kit or components thereof. In other embodiments, the instructions are present as an electronic storage data file present on a suitable computer readable storage medium, such as a flash drive. In other embodiments, the actual instructions are not present in the kit, but means for obtaining the instructions from a remote source, such as via the internet, are provided. An example of this embodiment is a kit that includes a web address where the instructions can be viewed and/or from which the instructions can be downloaded. As with the instructions, this means for obtaining the instructions is recorded on a suitable substrate.

Advantageous, the plasma jet assembly 100 leverages the capabilities of a dielectric anapole structure, a non-radiating resonator, to enhance the near electric field while effectively suppressing far-field radiation. Some key advantages of the anapole device include its high electron density, compact form factor, seamless integration capability, frequency tunability, and cost-effectiveness.

### Example 1

### A Microwave Anapole Source Based on Electric Dipole Interactions Over a Low-Index Dielectric

Non-radiating sources represent intricate current charge configurations that do not emit radiation beyond their source domain. A single non-radiating source comprising a low-index dielectric disk excited by a split ring resonator was evaluated. Employing analytical and numerical methods, it was demonstrated that this configuration supports an anapole state, exhibiting minimal or no radiation, effectively representing a non-radiating source. The radiation suppression is accomplished through the destructive interference of electric dipoles excited on the metallic and dielectric components of the split ring resonator. The design achieved impressive numerical and experimental agreement, affirming the formation of the anapole state using the lowest order multi-poles. Moreover, the anapole device can be compact, constructed from a low index dielectric, and can employ readily available components. As a versatile platform, the device can be utilized in diverse applications, including sensing, wireless charging, RFID tags, and other non-linear applications.

Accelerating charges emit electromagnetic (EM) radiation in the far field to preserve the stability of matter composed of atoms and molecules. This insight played a crucial role in Bohr's formulation of his renowned postulates and eventually laid the groundwork for quantum mechanics. However, from the early days, scientists have been trying to find the confined charge-current configurations that do not radiate. The oscillatory motion of a charged sphere within a single period is one such configuration. In this context, a particular charge configuration known as the “Anapole” was introduced in elementary particle physics by Yakov Zel'dovich. However, the experimental detection of the anapole effect remained challenging until others successfully observed and measured it in a cesium atom through parity-violating effects.

The electrodynamics analogue of an anapole or nonradiating (NR) source is achieved through the co-location of fundamental electric and magnetic dipoles, along with their toroidal counterparts. This spatial arrangement leads to far-field destructive interference, resulting in minimal or negligible radiation due to their similar but out-of-phase field distributions. The toroidal dipole emerges as the third-order term in the Taylor expansion of electromagnetic potentials, complementing other essential dipole moments defined in both Cartesian and spherical harmonics representations. The toroidal dipole was experimentally realized utilizing the unique response of a metamaterial. An anapole was observed experimentally using metasurfaces under plane wave excitation in the microwave spectrum. Subsequently, a simple silicon disk was employed to demonstrate an optical anapole.

Due to their exceptional characteristics, including near-field enhancement, high-quality factor (Q), and farfield suppression, anapoles have garnered significant attention. This heightened interest has led to a series of advancements in anapole technology, along with the introduction of new applications in sensing, power transfer, and quantum technologies. However, these developments are primarily limited to plane wave excitations. Hence, expanding the scope of anapole technology to accommodate other excitation methods may unlock additional opportunities for innovative applications beyond the current plane wave structures.

A novel single anapole source may employ a dipole surrounded by four high refractive index cylinders. In this configuration, the central dipole excites an electric toroidal dipole in the surrounding rods, leading to destructive interference and the formation of the anapole state. Anapole formation may also be achieved using a high refractive index cylinder, excited either by an electric dipole with a metallic rod in the middle or by a magnetic dipole with a loop placed inside the cylinder. In the former approach, the superposition of electric dipoles and electric toroidal dipoles forms the anapole state, while in the latter approach, only magnetic dipoles are superimposed to create the anapole configuration. Anapole state may also be achieved using a high refractive index disk excited by an external loop, which leads to the superposition of electric dipoles and quadrupoles. However, these structures rely on high refractive index materials, which may be custom-made and not commercially available.

This example presents an anapole source composed of a commercially available and low-index dielectric cylinder coupled with a simple excitation topology. This example demonstrates that if combined with a loop as a radiation source, a low-index dielectric cylinder can effectively showcase the anapole state. By analyzing the Cartesian multi-pole expansion in the long wavelength approximation, the feasibility of anapole formation at the lowest order using only dipole-dipole interactions was confirmed. For experimental realization, a dielectric cylinder was placed on a metallic plate, excited by a microstrip line coupled through an etched slot on the metallic plate. This configuration resulted in a significant size reduction compared to existing anapole sources, making it compatible with the printed circuit board (PCB) fabrication technology, and enables effective impedance matching, a challenge often encountered in anapole-based designs.

The proposed design includes its exclusive dependence on the lowest-order electric dipoles, facilitating a compact size even with a low dielectric constant, such as ϵᵣ=12.85, as opposed to previous works which utilized Er in the range of 1000. The overall size is 0.28λ_{g} compared to around 4λ_{g}, where λg represents the wavelength in the dielectric medium, equating to an almost 14 fold reduction in size. Moreover, its compatibility with existing fabrication technologies allows for commercial prototyping and facilitates the rapid development of various potential anapole-based applications in wireless sensing, charging, and non-linear electromagnetics/optics.

The anapole design depicted in FIG. 13 includes two metallic rods connected by a metallic strip configured to form a loop. This loop radiates like an electric dipole and induces a nearly equal but opposite electric dipole in the surrounding dielectric cylinder. As a result, the two dipoles destructively interfere, giving rise to an anapole state. The design's non-radiating response is highly sensitive to the gap between the two metallic rods. A narrower gap leads to lower radiation, making it factor to tailor the design for specific applications. The dielectric cylinder has a radius R=6 mm and height h=40 mm, with metallic vias each of radius r=0.5 mm, with center-to-center distance of s=0.6 mm, such that the top ends are connected, forming a split ring resonator (SRR). The dielectric cylinder is made of Rogers TMM13i laminate with permittivity of 12.85 and tan δ=1.9×10⁻³.

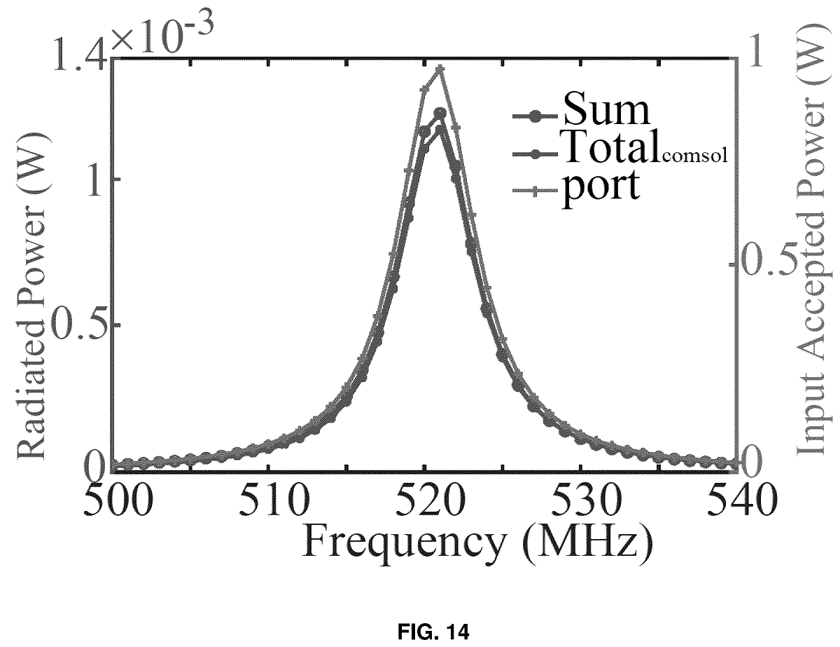

The radiation performance of the anapole design was initially explored through numerical simulations using COMSOL multi-physics, as depicted in FIG. 14. At the resonant frequency of 520 MHz of a sample design, the maximum radiation amounts to just 1.4 mW out of the total input power of 1 W, representing only 0.14% of radiated power. Remarkably, only 0.04% of this radiation is attributed to the electric dipoles, and the rest is from the magnetic dipole component, as plotted in detail in FIG. 14.

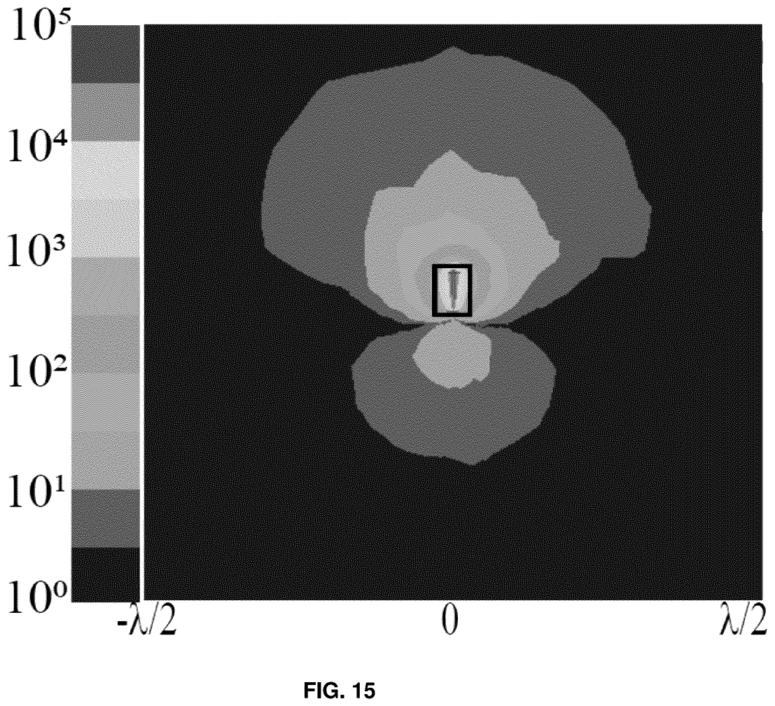

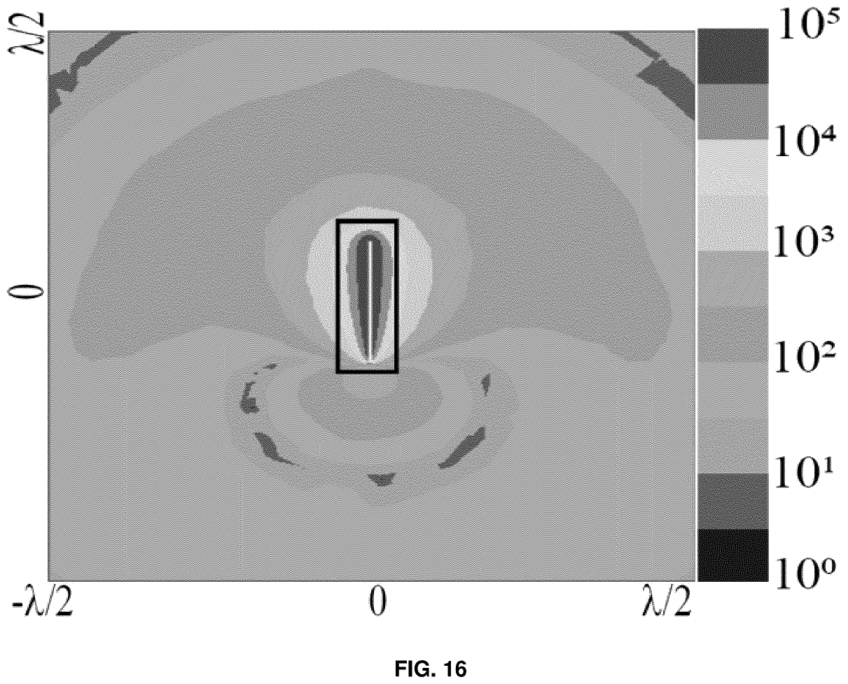

The loop without a dielectric cylinder was also simulated for radiation comparison. A resonating response is observed around 1.812 GHz with a radiation efficiency exceeding 98%. The near-field plots of the YZ plane for both non-radiating and radiating cases are illustrated in FIGS. 15-16, respectively. From FIG. 15, it is evident that the electric field diminishes rapidly compared to the radiating state, as depicted in FIG. 16. The reduction rate is over 100 times in the non-radiating state compared to the radiating state. The remarkable confinement of electric and magnetic fields in the proximity of the device, coupled with the significant suppression of far-field radiation, provides compelling evidence of the successful formation of an anapole state.

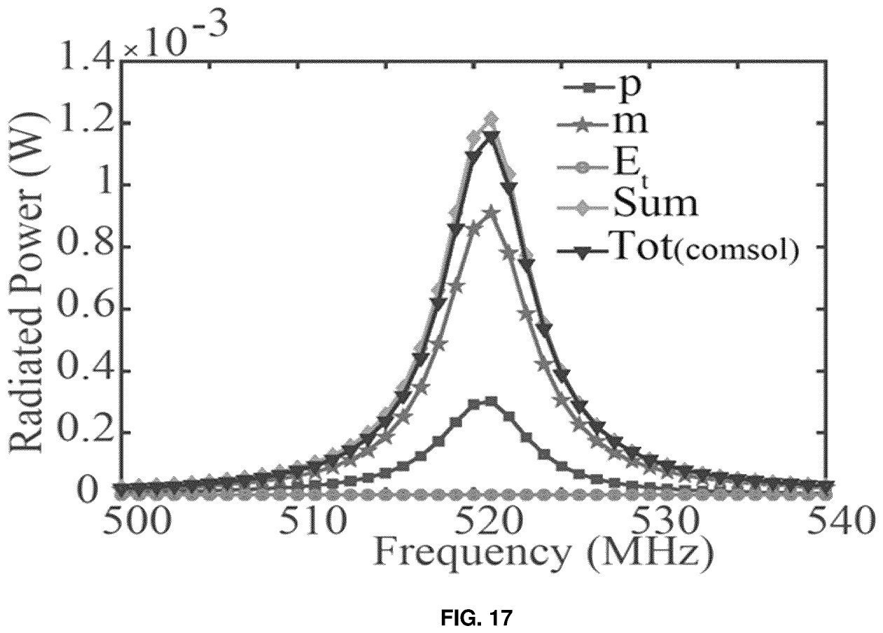

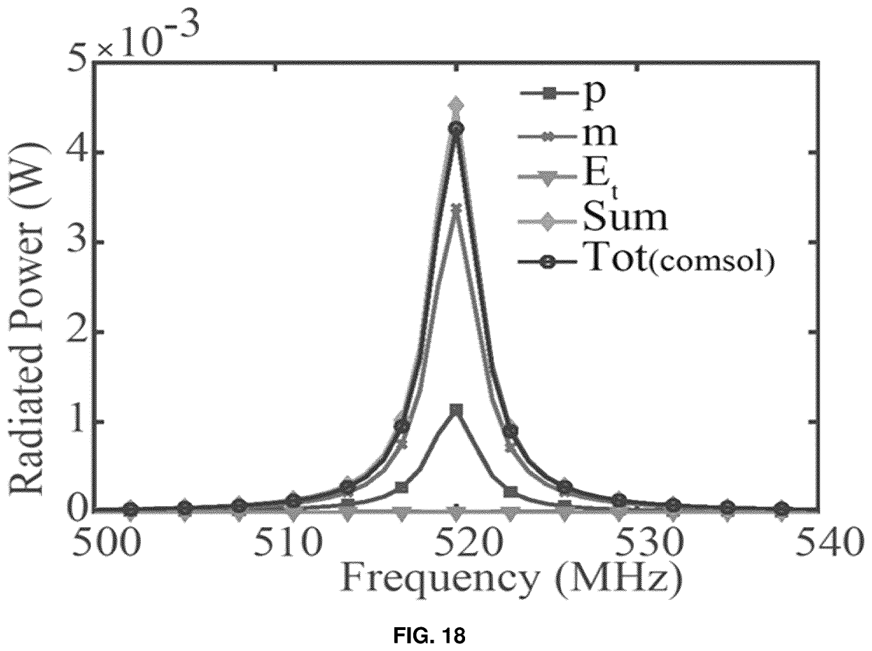

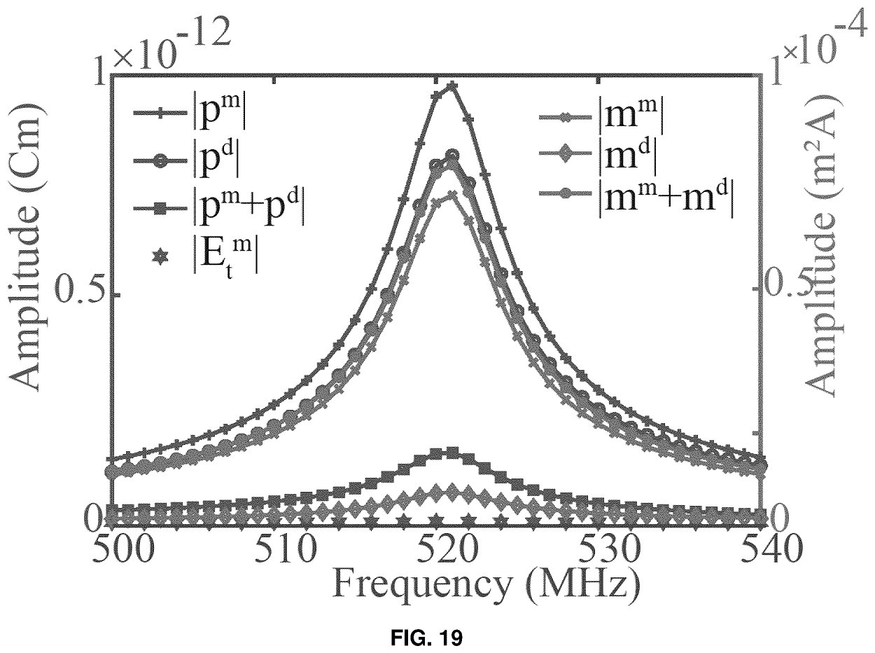

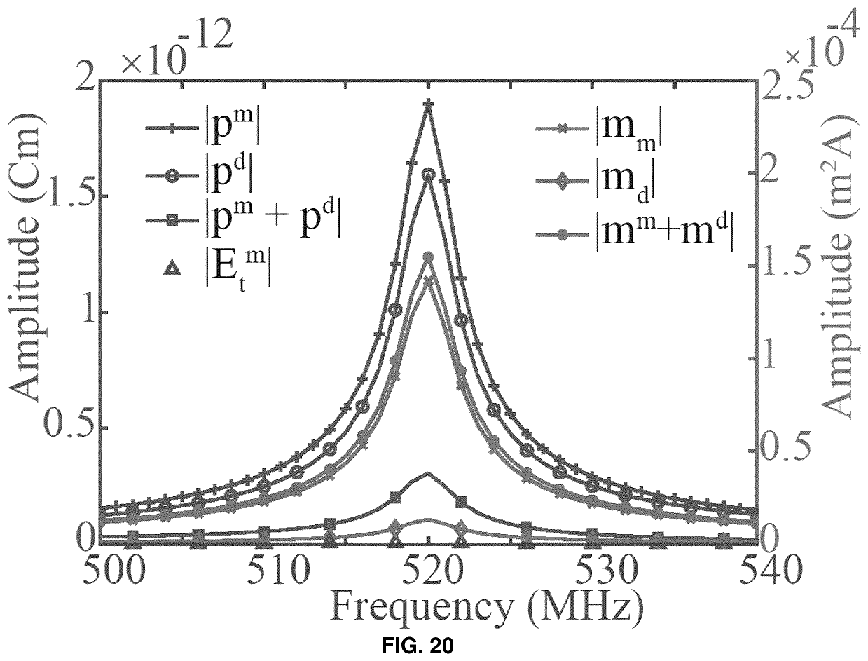

To gain an understanding of the non-radiating response's underlying mechanism, a Cartesian multi-pole expansion of the EM fields was conducted. The results are depicted in FIGS. 17-20 for two different separations between the metallic rods, s. Notably, FIGS. 17-18 clearly demonstrate that a smaller s leads to more pronounced radiation suppression. This observation aligns with the theory of electric dipole interactions. As radiation contributions are solely attributed to electric and magnetic dipoles, separate characterizations of these dipoles on both the metallic loop and the dielectric section were performed, with the results shown in FIGS. 19-20. These results reveal that the electric dipoles induce a destructive interference on the loop, similar to that observed in the dielectric region, whereas the magnetic fields exhibit constructive interference. Additionally, the toroidal dipoles contribute almost negligibly to the overall response. Consequently, the expression for this non-radiating electric source can be represented as:

$$P ∼ {\vert {p}^{m} + {p}^{d} \vert}^{2} = {\vert {p}^{m} \vert}^{2} + {\vert {p}^{d} \vert}^{2} + 2 RE [ {p}^{m} {p}^{d} * ]$$

where p^{m} is the electric response of the metallic loop, p^{d} represents the electric response of the dielectric cylinder, and (p^{m})+p^{d}) is the total electric response of the structure.

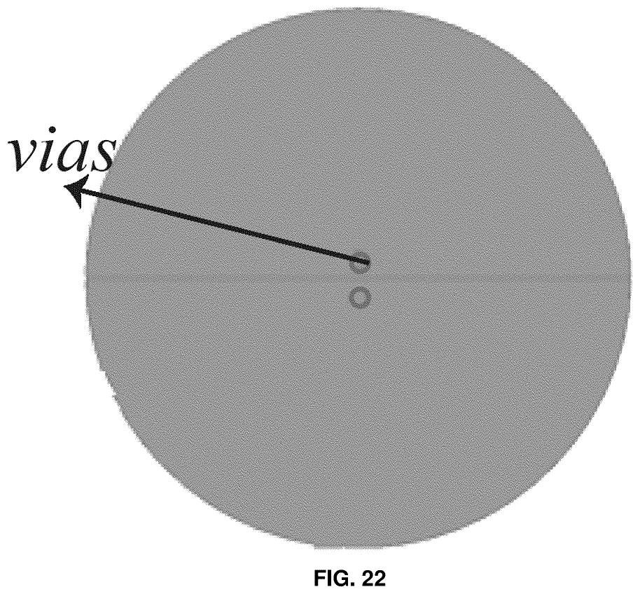

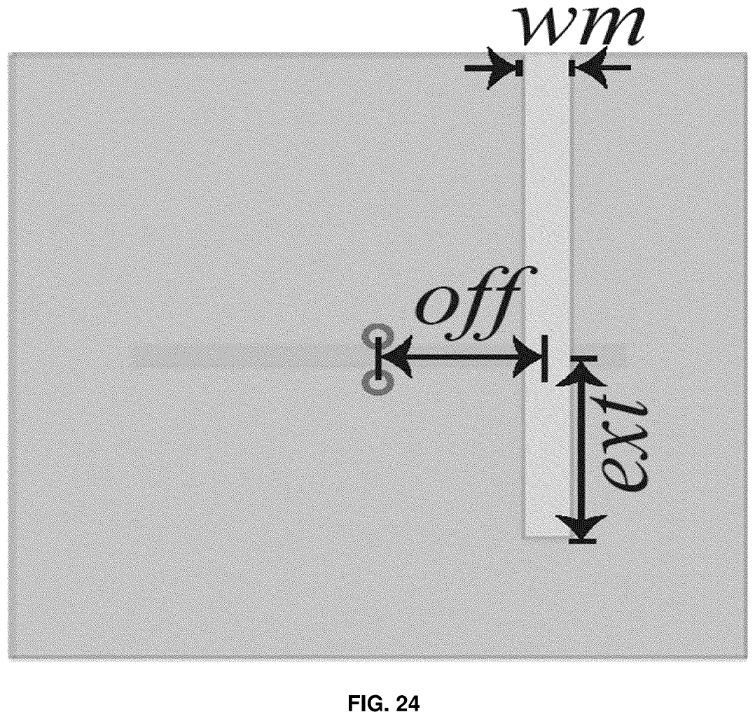

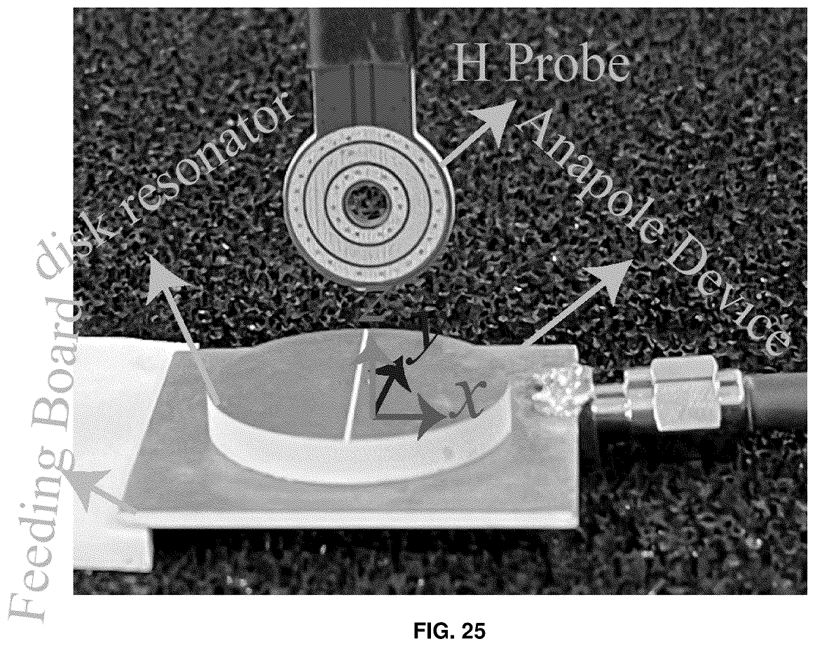

A cylindrical disk was crafted from a commercially available Rogers TMM13i laminate, featuring a thickness of 3.81 mm and 35 μm copper cladding. For the feeding section, another layer was fashioned from a 1.27-mm thick Rogers TMM6 laminate with the same 35 μm cladding. The assembly process involved aligning the disk with the feeding board using vias and holes, which was then secured using silver epoxy. The detailed design is shown in FIGS. 21-25. R=14 mm, thickness of the dielectric cylinder h=3.81 mm, thickness of feed board h₂=1.27 mm, Iₛ=20 mm, l=40 mm, wₘ=2 mm, ext=9 mm, off=6.9 mm, wₛ=1 mm, tₛ=0.3 mm, and s=1.2 mm. The cylindrical resonator is made of TMM13i with permittivity of ϵᵣ=13 and tan δ=1.9×10³. The bottom board is made of TMM6 with permittivity of ϵᵣ=6 and tan δ=2.3×10⁻³.

The EM energy was fed to a 50-02 microstrip line coupled to the dielectric resonator through the slot etched on the ground plane. Fine-tuning the slot's position relative to the microstrip line allows impedance matching. A top metallic pattern was utilized atop the dielectric resonator for further size reduction. The resulting prototype was remarkably compact, with its largest dimension lower than 0.12. To facilitate field measurements, a monopole and a loop receiver acting as an E and H probes, respectively, were utilized.

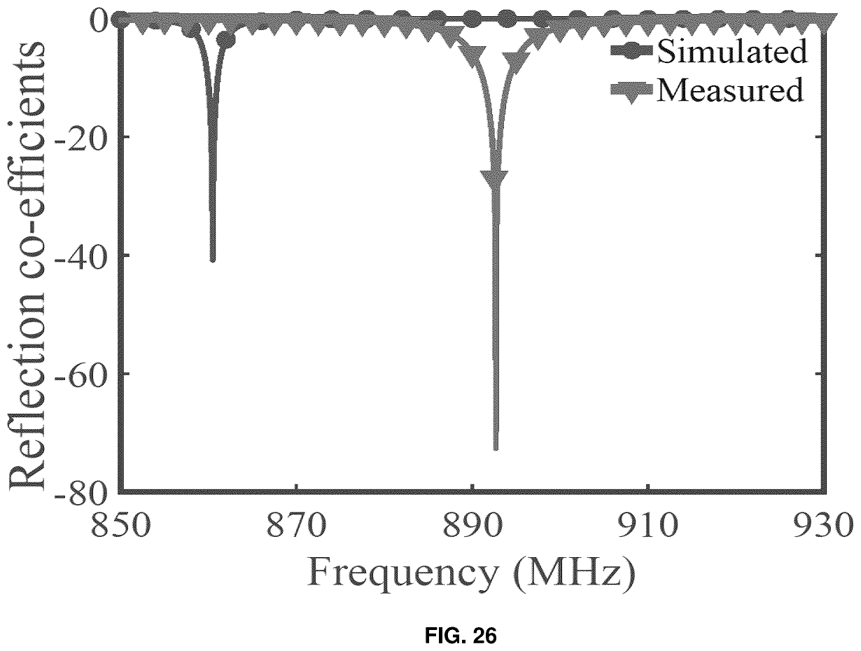

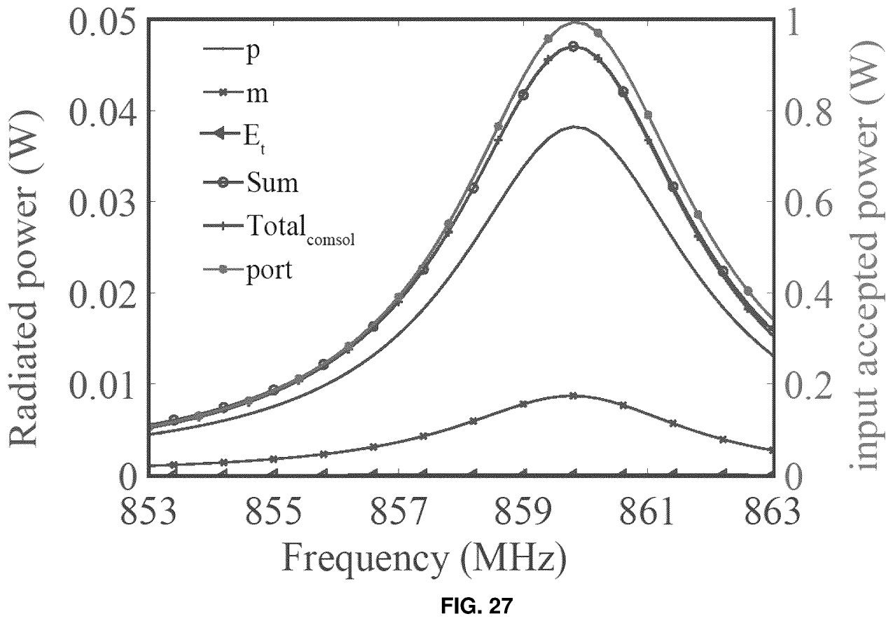

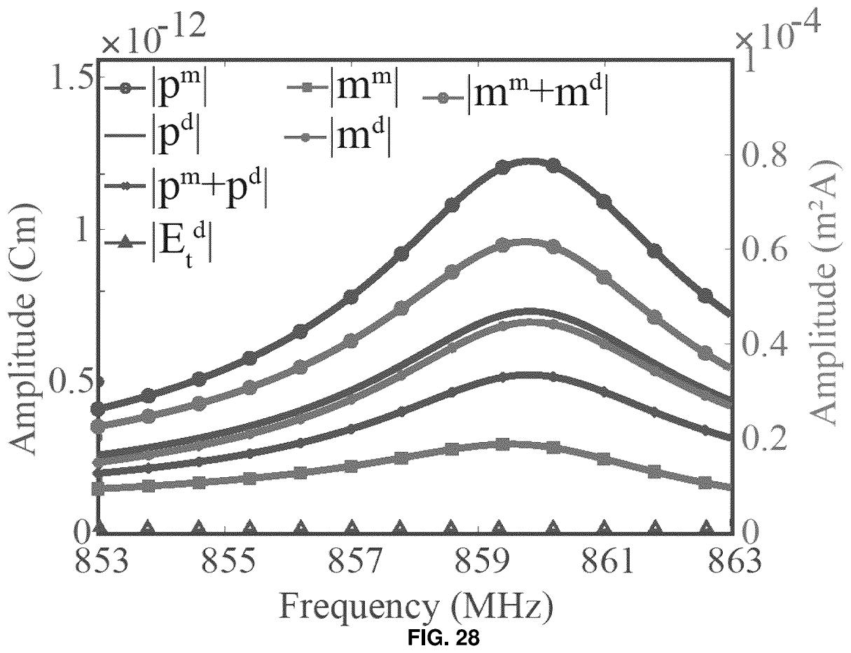

The simulated and measured return losses were plotted in FIG. 26. A strong resonance was observed at approximately 893 MHz, with around a 30-MHz deviation compared to the simulation. This variance is attributed to the manual alignment of the disk and the fabrication tolerances. Subsequently, a Cartesian multi-pole expansion analysis was conducted showing that less than 50 mW out of 1 W accepted power is radiated, with a contribution of only 35 mW from the electric dipoles as can be seen from FIGS. 27-28. Further reduction of this radiation is feasible by narrowing the gap between the vias; however, practical limitations pertaining to fabrication tolerances should be considered. Moreover, the individual contributions of electric and magnetic dipoles were evaluated separately on the metallic and dielectric portions of the structure. The experimental results validate the achievement of significant radiation suppression.

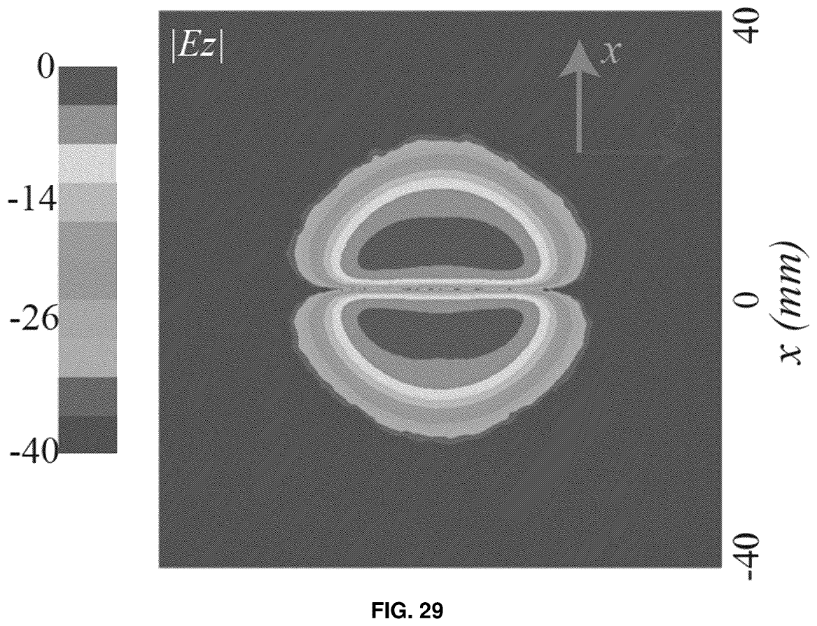

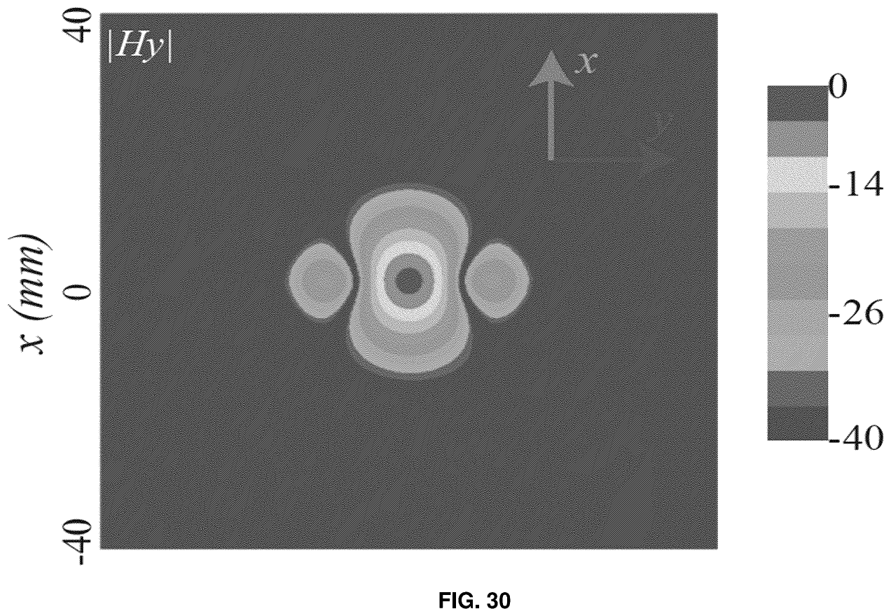

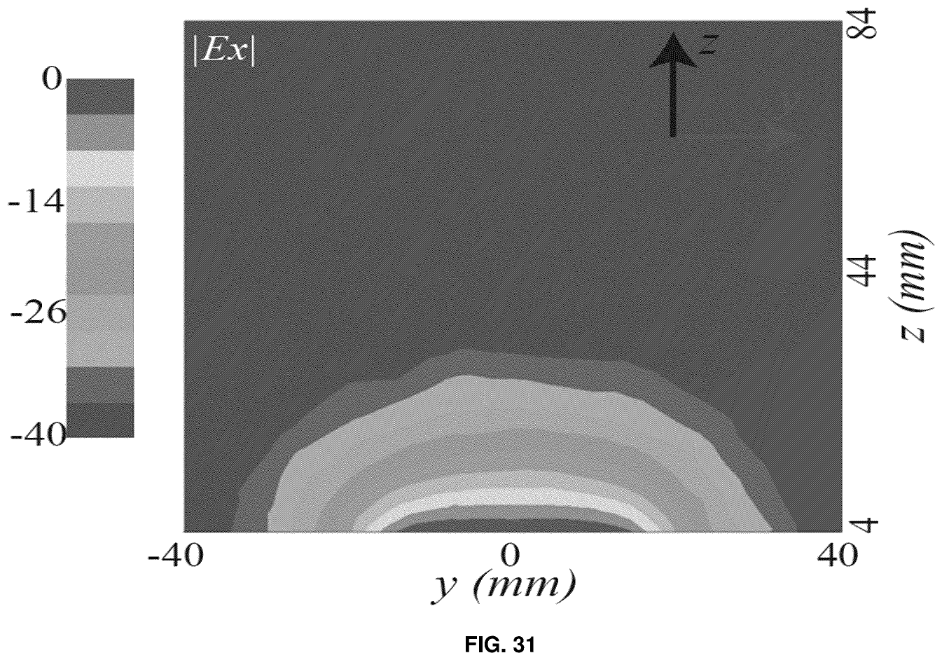

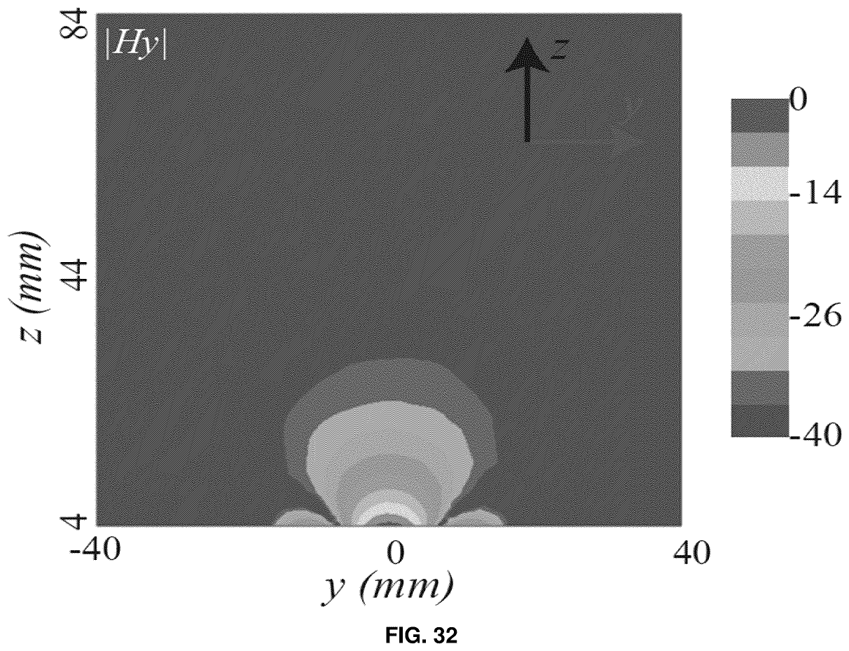

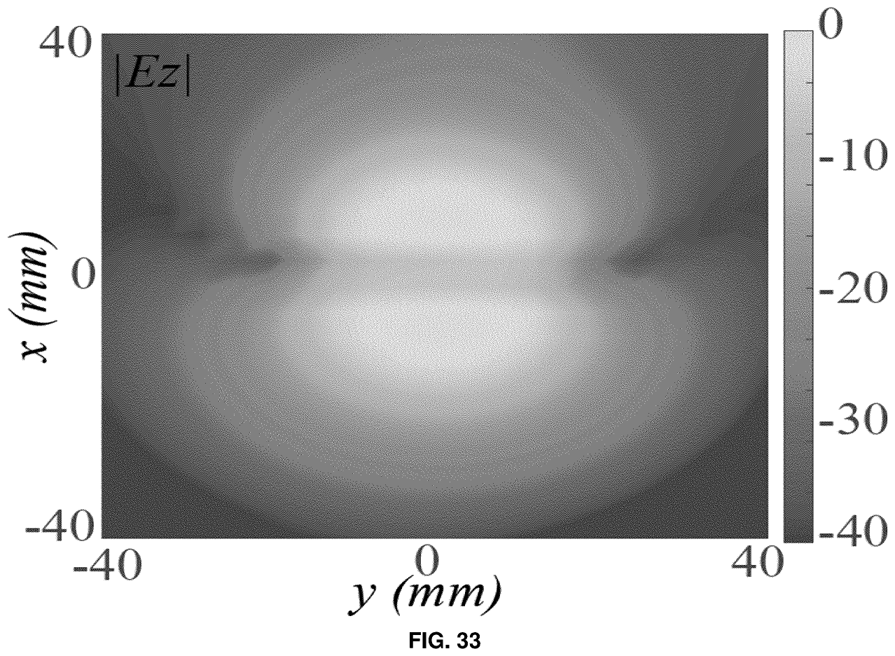

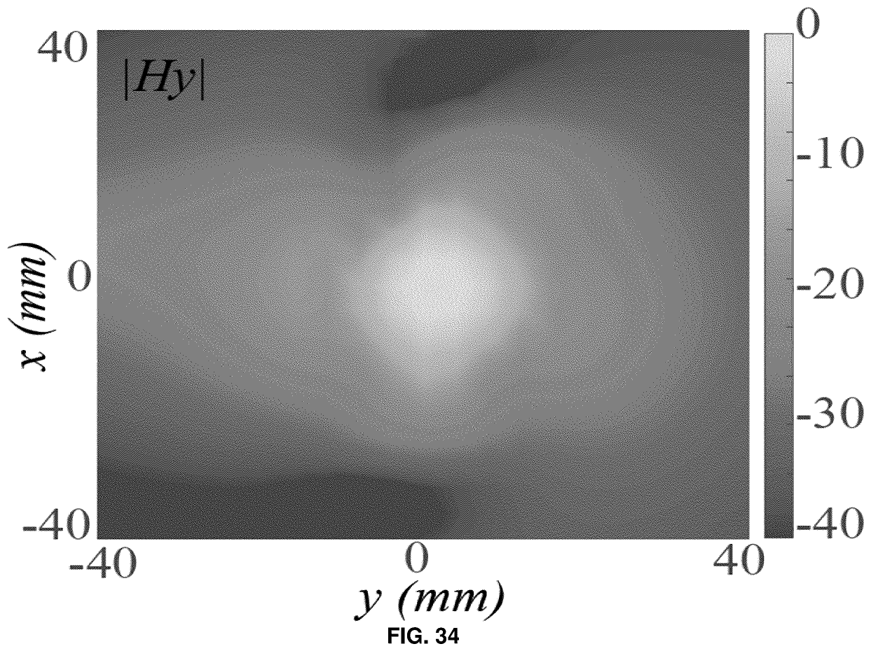

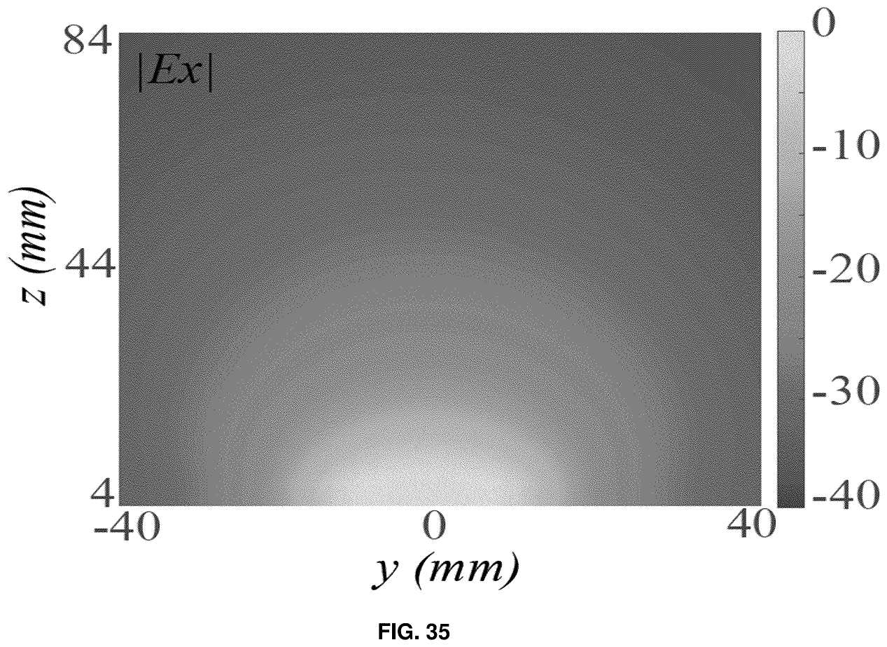

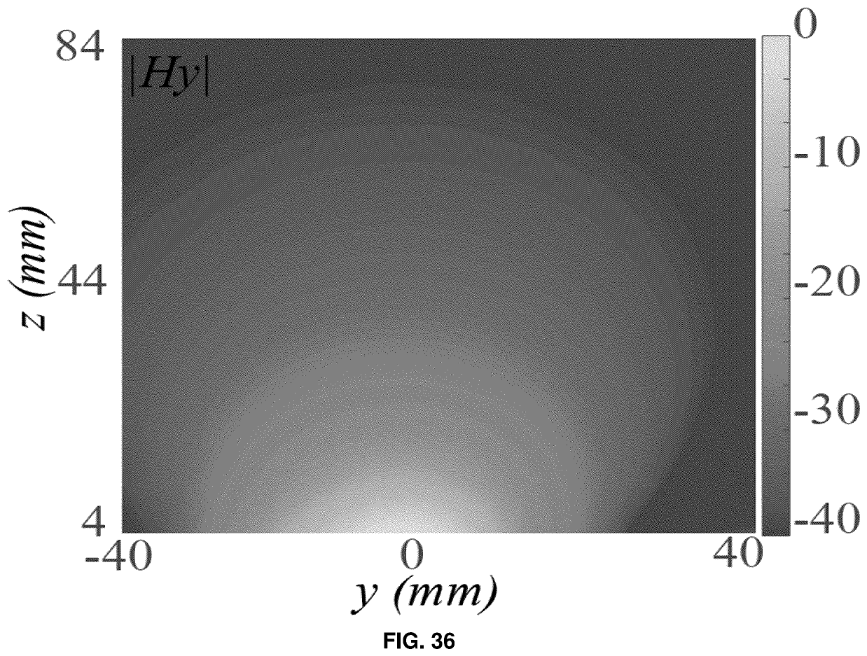

The near-field investigation of the prototype was conducted through both numerical simulations and experimental measurements, as depicted in FIGS. 29-36. Among the field components, only Eₓ, E_{z}, and H_{y} demonstrate significant contributions, while the remaining field components are nearly negligible and can be safely disregarded.

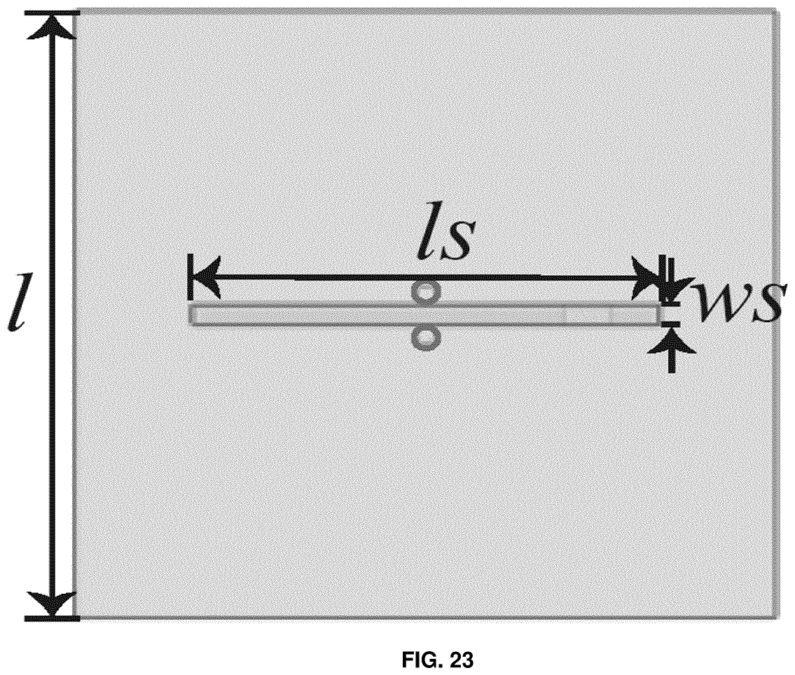

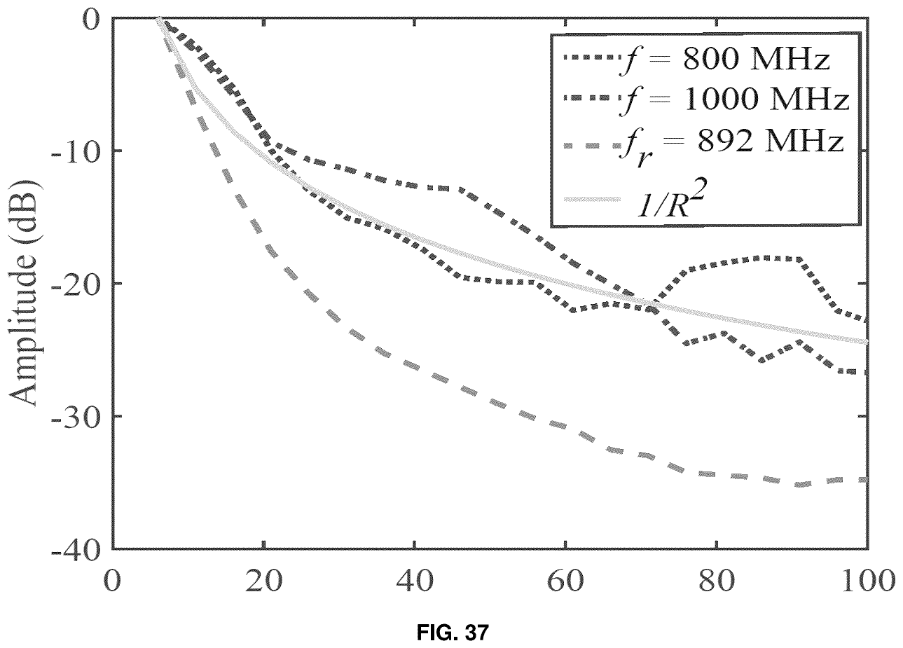

To facilitate the measurements, a monopole probe was employed for E-field measurements, while a loop-shaped probe was utilized for H-field measurements. As shown in FIG. 23, the probes were oriented strategically, aligning their axes along the y-axis to best couple with the maximum H_{y} field and vertically for the monopole probe to couple maximally with E_{z}. The field plots exhibited an excellent agreement between the simulations and measurements, revealing a robust suppression of the fields, confined within a few fractions of a wavelength away from the device. Moreover, the decay of the electric field at the resonance frequency and two adjacent frequencies, one above and one below, is compared with distance from the device alongside 1/R². As depicted in FIG. 37, the electric field decay was significantly higher at the anapole frequency compared to the other frequencies, which exhibit a decay rate more closely aligned with 1/R². This conclusion is similarly evident from the comparison depicted in FIGS. 15-16 for the outgoing waves of the radiating and non-radiating states. This observation serves as a clear indication of the successful formation of the anapole (non-radiating) state.

The anapole state does not inherently arise as a natural eigenstate within an open cavity. It only manifests in the presence of an incident field, setting it apart from bound states in a continuum or traditional eigenstates. However, the anapoles are externally excited and sustained, distinct from scattering effects. The fact that the anapole state results in the cancellation of far-field interaction of various dipolar responses enables the near-field enhancement around the device, which can be utilized for multiple applications compared to cavities in which fields are confined within metallic enclosures.

### Example 2

Anapoles Enabling Highly-Efficient Plasma Jets within Dielectric Structures

The confinement of EM waves or light within meta-structures on a sub-wavelength scale has emerged as a crucial platform for exploring fundamental wave-matter interactions and a wide range of applications, particularly in wireless and optical domains. In wireless applications, filtering, and energy transfer, achieving high-quality wave confinement within resonating structures is paramount. Consequently, concepts such as “bound states in the continuum” and “anapoles” can enhance wave confinement and provide high-Q resonances. However, due to the non-existence theorem, perfect bound states in a continuum cannot be realized in isolated structures. Conversely, anapoles represent charge current configurations that can be achieved through external excitation, inducing multipole moments within the structure that produce equal but out-of-phase far-field radiation.

The initial demonstration of anapoles harnessed the interference between electric and magnetic dipoles, primarily focusing on toroidal dipoles, as a means to minimize outgoing scattering. Subsequently, anapoles have evolved beyond the confines of toroidal dipoles and have been realized through various combinations of other multipole configurations. This versatility has prompted extensive exploration within the context of plane wave scenarios. Achieving dipole-like excitation of anapoles is beneficial for more compact devices. However, a significant challenge lies in the requirement for high dielectric constant materials, which has posed a substantial barrier to practical applications. The prior example demonstrated a compact anapole technology utilizing the lowest-order electric dipoles in conjunction with readily available, low-dielectric-constant materials.

While anapole sources are energy storage devices, their storage capacity is inherently constrained by the materials used in their construction. The augmented electric field generated by the presence of anapoles has the potential to initiate gas breakdown at much lower powers than usual, enabling the creation of efficient plasma sources. Plasma is pivotal in diverse fields, including medicine, materials processing, agriculture, and space applications. In medicine, for instance, cold atmospheric plasma finds application in wound healing, cancer treatment, and dental procedures, thanks to the generation of many reactive oxygen and nitrogen species. Material processing leverages plasma for surface treatment, coatings, welding, and the processing of quartz and ceramics. In agriculture, plasma technology is extensively explored for pre-planting, pre-harvest, and postharvest applications, including DNA modification, disinfection, and pathogen control, among others. Furthermore, plasma holds importance in electric propulsion and fusion technologies. Given its profound impact across various aspects of daily life, developing efficient plasma sources is paramount.

Non-resonant sources, while effective, tend to be bulky and demand substantial power, giving rise to safety and electromagnetic interference concerns. In contrast, resonant plasma sources (RPS) offer an appealing alternative. In RPS, electromagnetic energy is concentrated at specific spatial locations within resonant structures, creating favorable conditions for gas breakdown and plasma formation. These RPS exhibit a range of advantageous features, including stable discharges, a higher degree of ionization and dissociation, elevated electron density, increased production of reactive species, lower plasma discharge temperatures, and reduced ignition voltage.

An atmospheric pressure microwave plasma jet has previously been developed, showcasing the ability to operate at a significantly reduced power of 500 mW, utilizing evanescent mode cavity resonator technology. For example, see U.S. patent application Ser. No. 18/075,523 to Semnani et al., the entirety of which is incorporated by reference herein. Similarly, plasma jets based on coaxial transmission line resonators have demonstrated operation at remarkably low input power levels of 1.5-3 W. Furthermore, to simplify and reduce the cost of manufacturing these intricate 3D structures, an approach involving substrate-integrated-waveguide (SIW) based cavity resonators was introduced. This enables the creation of a printed circuit board (PCB)-compatible plasma jet operating within the range of 15-30 W. In parallel, SIW based evanescent cavity resonators have been employed to achieve plasma jets operating at even lower power levels, typically ranging from 2.7 to 5 W. For example, see U.S. patent application Ser. No. 18/075,523.

A common issue with resonating plasma sources is the impedance mismatch before and after plasma ignition. This mismatch can reflect a high-power signal, posing a risk to the generator system. The severity of this problem escalates as the input power requirements increase, mainly when aiming for higher gas flow rates and longer jet lengths. A physical concept known as “virtual perfect absorption” (VPA) has been introduced to mitigate these reflection issues. VPA involves the excitation of an exponentially increasing complex input signal, which prevents the impedance mismatch by adjusting the incoming power concerning the internal losses and reflected power. However, the practical application of VPA remains limited and it has, thus far, been applied primarily under controlled conditions.

This example describes the development of highly efficient atmospheric plasma jets with minimal reflection and radiation losses using dielectric anapole structures. Unlike commonly employed cavity resonators, anapoles do not necessitate a metallic enclosure for radiation mitigation. The anapole structure for the plasma jet leverages only the lowest-order electric dipoles induced on both the metallic and dielectric components of the device to minimize radiation losses through the destructive interference of outgoing waves. The device can be planar, and exceptionally compact, and can seamlessly integrate with printed circuit board structures. Its cost-effectiveness is owed to its compatibility with PCB fabrication processes. Furthermore, the resulting plasma jets exhibit remarkable absorption efficiency, reaching as high as 94% at a low input power of 1.5 W and 62% at a high input power of 15 W. This means the plasma jet provides double the electron density compared to state-of-the-art resonant microwave plasma jets.

### Anapole Plasma Jet Theory and Design

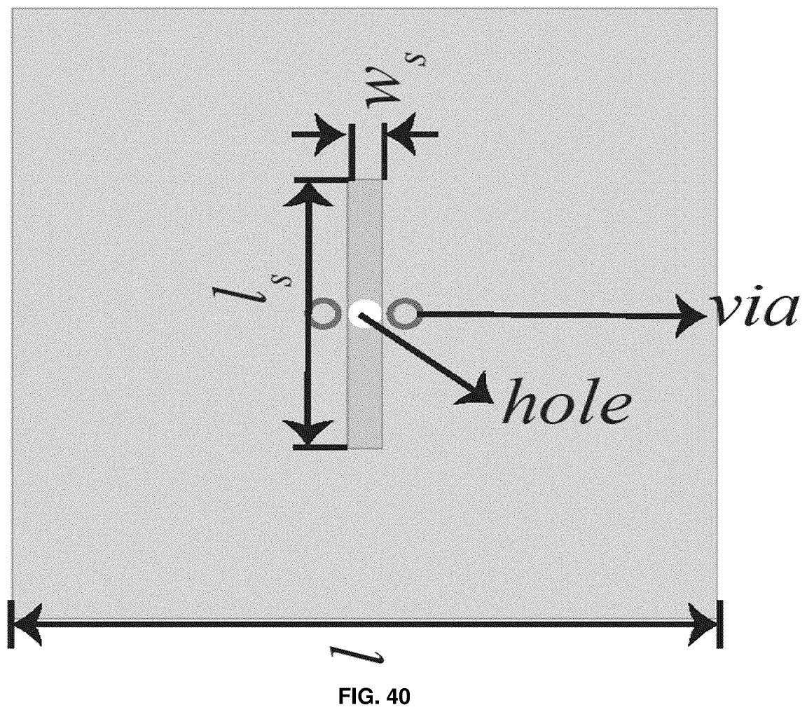

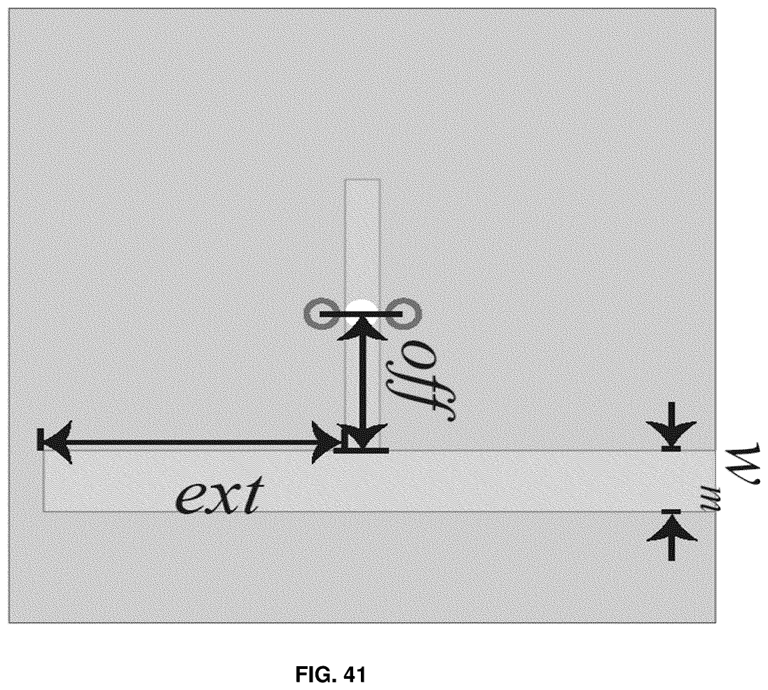

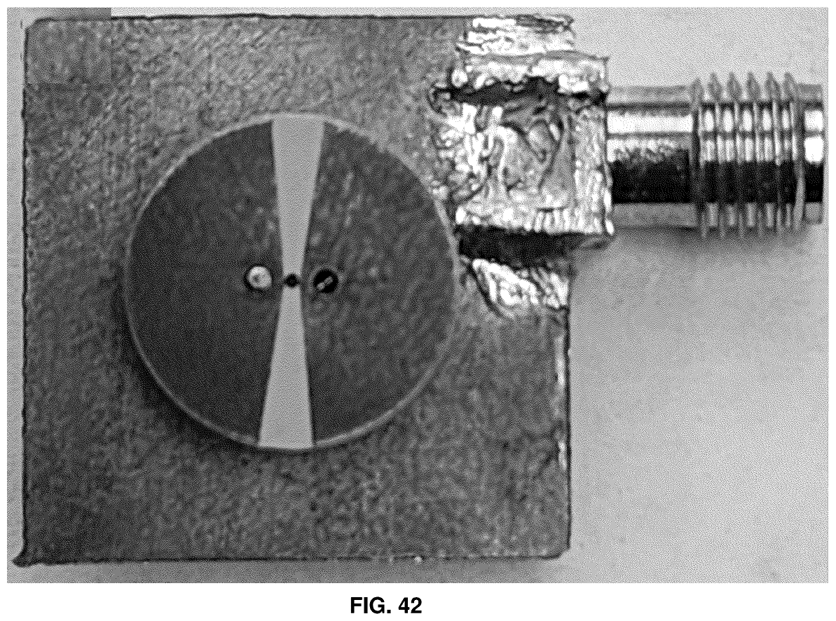

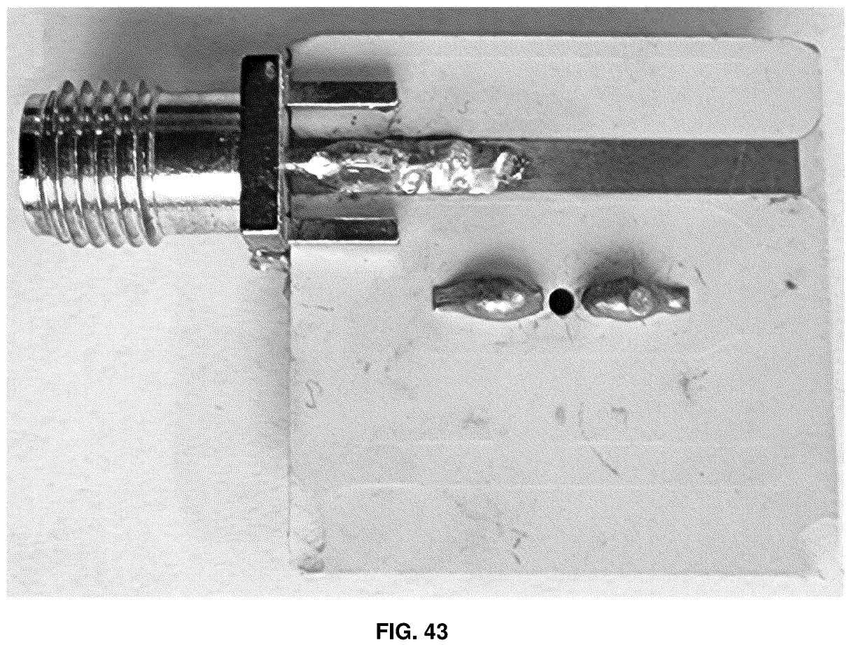

The hybrid metallo dielectric structure is shown in FIGS. 38-43. The anapole working mechanism is the inverse of antennas as radiation suppression is the main goal for anapoles. The radiation suppression in the anapole device is achieved with the excitation of the lowest-order multipoles, i.e., electric dipoles over the metallic and dielectric parts. The induced electric dipoles on both the metallic and dielectric components are strategically aligned to effectively cancel out far-field radiation while simultaneously enhancing the concentration of the near field. This interaction results in a substantial increase in the electric field strength in the vicinity of the device, which is used for gas breakdown, i.e., plasma generation.

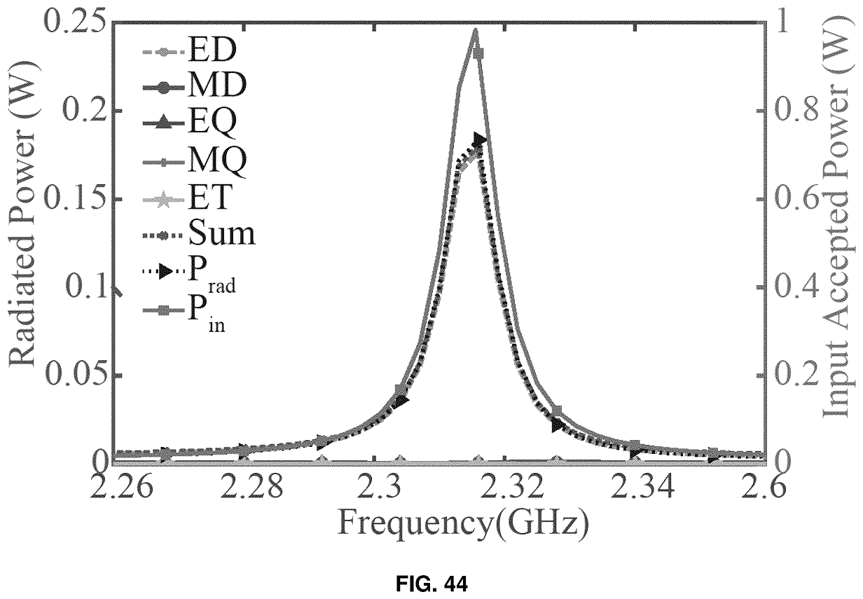

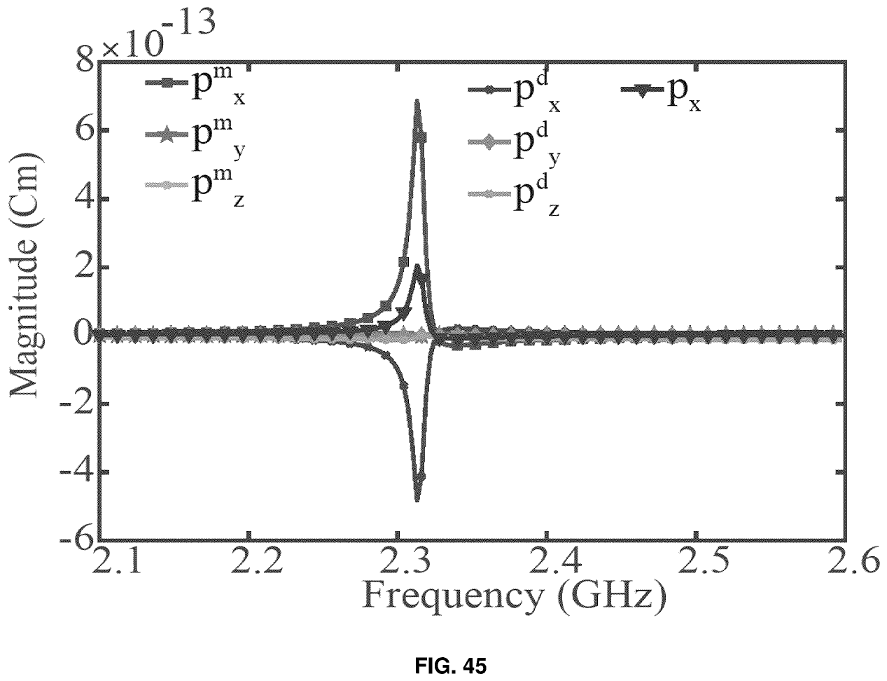

The Cartesian multipole analysis is performed over the anapole device, as shown in FIGS. 44-45. The overall radiation is around 190 mW out of 1 W, mainly contributed by electric dipoles. To analyze the underlying mechanism, the electric dipole strength is separately evaluated over metallic and dielectric parts. Only the x-aligned component is dominant, which is 180° out of phase between metallic and dielectric parts, resulting in radiation suppression. The anapole structure was built to realize an efficient atmospheric pressure plasma jet operating at 2.45 GHz.

The designed anapole structure is composed of two separate boards: a cylindrical dielectric disk and a feeding microstrip board. The cylindrical disk can be fashioned from a commercially available Rogers TMM13i laminate, possessing a thickness of 3.81 mm with a 35 μm copper cladding. This disk serves as the resonant element of the anapole plasma jet and incorporates vias to create a split-ring resonator configuration. The top and bottom copper patterns on the disk facilitate longer current paths, contributing to the compactness of the design. Additionally, a rectangular slot is etched into the disk's bottom layer to enable electromagnetic energy coupling from the feeding network to the dielectric resonator cavity. For the feeding board, another layer was fabricated from a 1.27-mm thick Rogers TMM6 laminate featuring the same 35 μm cladding with a 50-Ω microstrip line on the bottom side and a slot of identical dimensions on the top. The positioning of the microstrip line, slot width (wₛ), and length (lₛ) have been selected to achieve excellent impedance matching at the resonant frequency of 2.45 GHz. The assembly process involved aligning the cylindrical disk with the feeding board using vias and metallic rods, which were then securely affixed using silver epoxy. The resulting device exhibits remarkable compactness, with its largest dimension measuring less than 0.12. Detailed design schematics and images of the fabricated device are provided in FIGS. 38-43, where r=11 mm, thickness of the dielectric cylinder h=3.81 mm, thickness of feed board h₂=1.27 mm, lₛ=8.83 mm, l=20 mm, wₘ=2 mm, ext=9 mm, off=5.3 mm, wₛ=1 mm, d₁=1 mm, d₂=0.5 mm, d₃=0.9 mm, and s=1.2 mm. The cylindrical resonator was made of TMM13i with permittivity of ϵᵣ=13 and tan δ=1.9×10³. The bottom board was made of TMM6 with permittivity of ϵᵣ=6 and tan δ=2.3×10⁻³.

To establish the gas flow mechanism for plasma jet formation, a 1-mm hole was drilled between the rods and extends to the center of the cylindrical disk. As the hole approaches the disk's surface, the hole was tapered down to a diameter of 0.5 mm. This final hole size ultimately determines the diameter of the plasma jet. A Teflon capillary tube was then threaded through this hole, extending from the feeding board to the midpoint of the disk. This capillary tube serves as the conduit for gas injection. Positioning the hole at the disk's center within the dielectric resonator cavity is a deliberate choice, ensuring a sufficiently strong electric field for facilitating plasma ignition, as illustrated in FIG. 47. Furthermore, the slot on the top side of the disk is tapered to minimize the risk of air breakdown at various points along its length.

### Materials and Methods

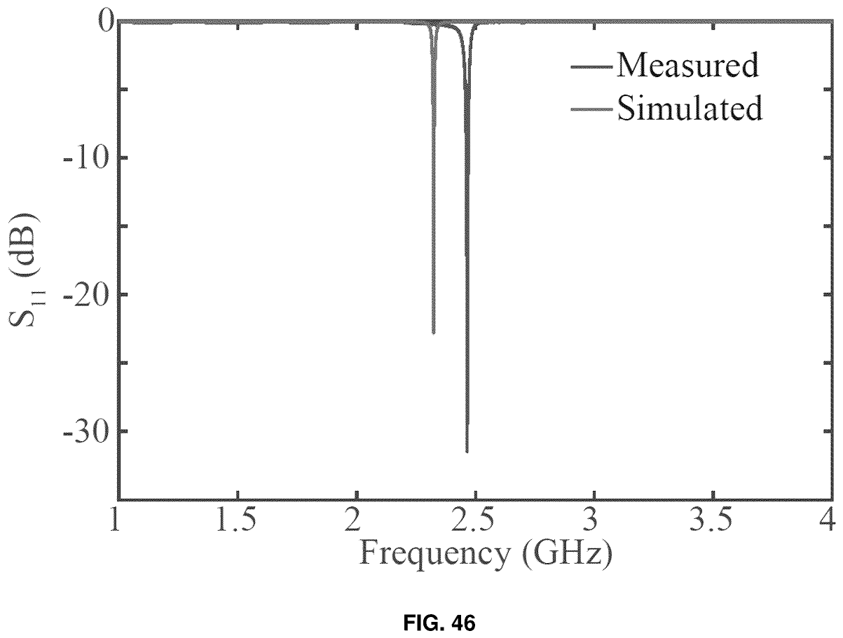

The anapole device was numerically evaluated using the High-Frequency Structure Simulator (HFSS) 2023 R1, employing the Eigenmode solver. This analysis yielded an estimated Q-factor reaching 256 at the design frequency of 2.45 GHz. Subsequently, the driven solution was used to assess the return loss near the resonance frequency, as illustrated in FIG. 46. The radiation loss was also determined, measuring 190 mW out of 1 W for the proposed plasma jet device.

The device was composed of two distinct components: (1) a cylindrical disk and (2) a feeding board, both of which are amenable to printed circuit board (PCB) fabrication techniques. The cylindrical disk was crafted from Rogers TMM13i laminate and incorporated two vias, along with a central hole, to prevent unintended air breakdown. The feeding board was constructed using Rogers TMM6 material. The feeding board was affixed to the disk using metallic rods of smaller dimensions than the vias, ensuring proper slot alignment. Silver epoxy was employed to fasten the disk atop the feeding board securely. Microwave energy was coupled to the device via a 50-Ω SMA connector.

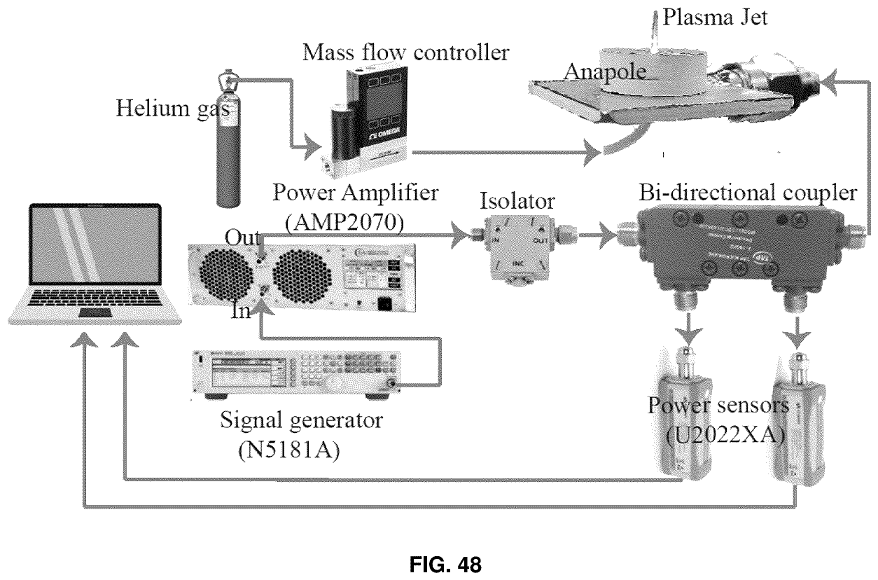

After the sample preparation, a vector network analyzer (VNA) was employed to measure the scattering parameters, as depicted in FIG. 46. Given that the device is an open structure, it is important to assess the stability of its frequency response to ensure best performance. A slight shift in the resonance frequency, around 1 MHz, was observed when a metallic sheet was brought into proximity with the device within a range of 2 to 4 mm. The low radiation characteristics of the anapole device make it well-suited for plasma ignition without the need for an enclosed metallic cavity. The setup for achieving plasma ignition is illustrated in FIG. 48. The signal generator N5181A generates a continuous wave (CW) signal at the resonance frequency, which is subsequently amplified by the AMP2070 power amplifier, providing approximately 57 dB of gain. The amplified signal passes through an isolator to safeguard the amplifier from back-reflected signals. Subsequently, the signal is routed through a 30-dB bi-directional coupler, where two power sensors, namely U2022XA, are employed to measure the input and reflected powers. A compressed helium gas cylinder is connected to a mass flow controller (MFC), which regulates the gas flow rate directed to the device. For a gas flow rate of 1 slpm, plasma ignition is achieved at an input power of 2.7 W and can be sustained with an input power as low as 1 W.

This setup was employed to assess the plasma efficiency. Given that the input and reflected powers were measured using a bi-directional coupler, it is important to account for the losses incurred by cables and components between the reflected port and the input port of the anapole device. These losses were determined through a VNA measurement and were factored in for precise power measurements at the input port of the anapole device. The absorbed power within the plasma can be readily derived from the reflected power, and the efficiency is subsequently calculated using the absorbed power and input power.

The Teledyne Princeton Instruments HRS-500-SS spectrometer was employed, which offers an optical resolution of 0.05 nm, to assess the spectral emissions. The optical sensor was positioned in close proximity to the device, approximately 1-2 mm away from the side, to prevent interference with the gas flow. This placement was configured to capture the most comprehensive spectral profile of the desired emitter. To ensure data stability and minimize variations, the sensor's exposure time was set to 10 seconds, allowing adequate time for the data to stabilize.

### Results and Discussions

The frequency response of the proposed device was initially assessed in the OFF mode, employing both numerical simulations and experimental measurements, as illustrated in FIG. 46. Notably, the gas flow was found to have an insignificant impact on the resonance frequency and can thus be considered a non-significant factor in this context. In the experimental measurements, a slight shift of approximately 130 MHz in the resonance frequency was observed compared to the simulation results. This deviation can be attributed to the fabrication tolerances inherent to the manufacturing process, as the initial design had aimed for a resonance frequency of 2.45 GHz. Remarkably, the achieved return loss, surpassing 20 dB, underscores that over 99% of the input microwave energy is efficiently coupled to the anapole device at the resonant frequency.

To induce gas breakdown, it is important to establish a high electric field of around 10⁵ (V/m) within the gas flow region. The electric field distribution was numerically evaluated in the anapole design, utilizing an input power of 1 watt, as illustrated in FIG. 47. Here, a maximum electric field strength of 1.4×10⁶ (V/m) was observed, accompanied by a radiation loss of approximately 190 mW out of the 1-W input power. A potential strategy for reducing radiation loss involves employing a narrower slot on top of the disk without tapering. However, this may increase the risk of undesired air breakdown, which is undesirable in the context of a plasma jet device. Furthermore, it is noteworthy that the peak electric field strength remains unaffected by the heightened radiation loss resulting from slot tapering.

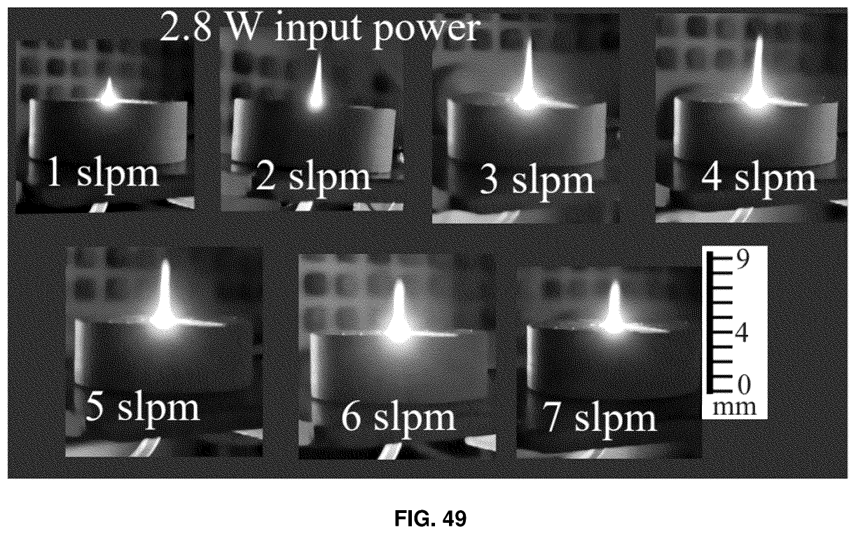

To test the device in ON mode, helium gas was introduced into the device at 1 slpm. At 2.7 W of input microwave power at the resonant frequency, gas breakdown occurred, leading to the formation of a plasma jet. Due to the reduced effective area post-breakdown, even lower power in the 1-W range proved sufficient to sustain the plasma jet after ignition. To gain further insight into the characteristics of the plasma jet, the helium flow rate was varied, ranging from 1 to 7 slpm, and the resulting plasma jets are depicted in FIG. 49. Notably, the plasma jet length exhibited an increasing trend with increasing flow rate until it reached 5 slpm, at this point, an ideal plasma jet configuration was observed. Beyond this flow rate, the jet length began to decrease.

The nature of gas flow plays an important role in shaping the plasma jet and is contingent upon factors such as the channel type and gas properties. This relationship can be elucidated with the assistance of the Reynolds number. The Reynolds number is a dimensionless parameter that can be computed to gauge the degree of turbulence within the gas flow as:

Re=ρνd/η

where ρ, ν, and η represent the fluid's density, velocity, and viscosity, respectively. In the context of gas flow within a cylindrical channel, d is the channel diameter, which measures 0.5 mm in this study. A Reynolds number below 2000 signifies a laminar flow regime, resulting in a uniform, needle-like jet, while a value exceeding 3000 indicates turbulent flow, which is generally undesirable. The gas velocity can be calculated based on the gas flow rate under standard conditions as follows:

$$v = 4 D / π {d}^{2}$$

Here, D represents the gas flow rate in slpm. Helium possesses a density of ρ=0.1634 kg/m³ and a viscosity of η=1.94×10⁵ kg/(m·s). According to Re=ρνd/η, when D is less than 5 slpm, the calculated Reynolds number remains below 2000, indicating a laminar flow regime. This laminar flow is desirable for achieving a uniform plasma discharge, a characteristic that aligns well with the experimental observations presented in FIG. 49.

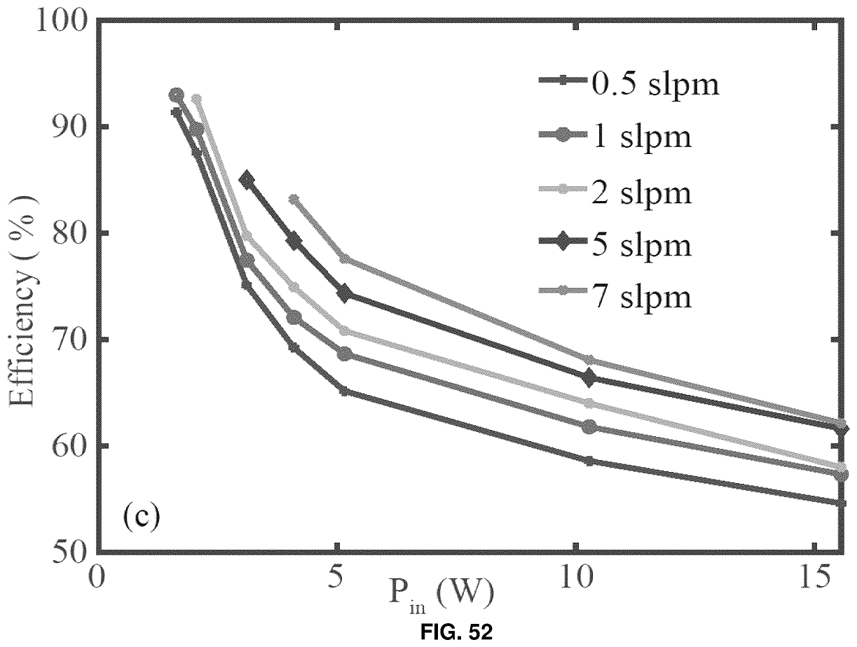

The plasma jet's efficiency was experimentally characterized. The device exhibits a reflection coefficient of approximately −20 dB in the OFF mode. However, when plasma ignites, it perturbs the frequency response due to the creation of a relatively conductive plasma region positioned directly within the high-field region of the structure. Experimental measurements were conducted to determine the input and reflected powers at various flow rates, enabling the calculation of the absorbed power by the plasma. Based on these numbers, the device's efficiency was calculated is depicted in FIG. 52. It was observed that the proposed anapole plasma jet consistently maintains a relatively low reflection, even at high operating powers. This characteristic highlights that the need for circulators and couplers can be circumvented without compromising the safety of the microwave sources, as is often required in the case of conventional resonant plasma jet sources.

The absorption efficiency of the anapole device is impressively high, reaching 94% at a low input power of 1.5 W and 62% at a higher input power of 15 W. This level of efficiency sets the anapole device apart from earlier plasma jets, particularly those designed for low-power operation. For instance, the efficiency of the anapole device significantly surpasses that of evanescent-mode cavity resonator-based plasma jet, which achieved 80% efficiency at 1 W and 18% efficiency at 15 W input power. Similarly, the anapole device outperforms coaxial transmission line resonator-based plasma jets, which attain 80% efficiency at a low input power of 1.5 W.

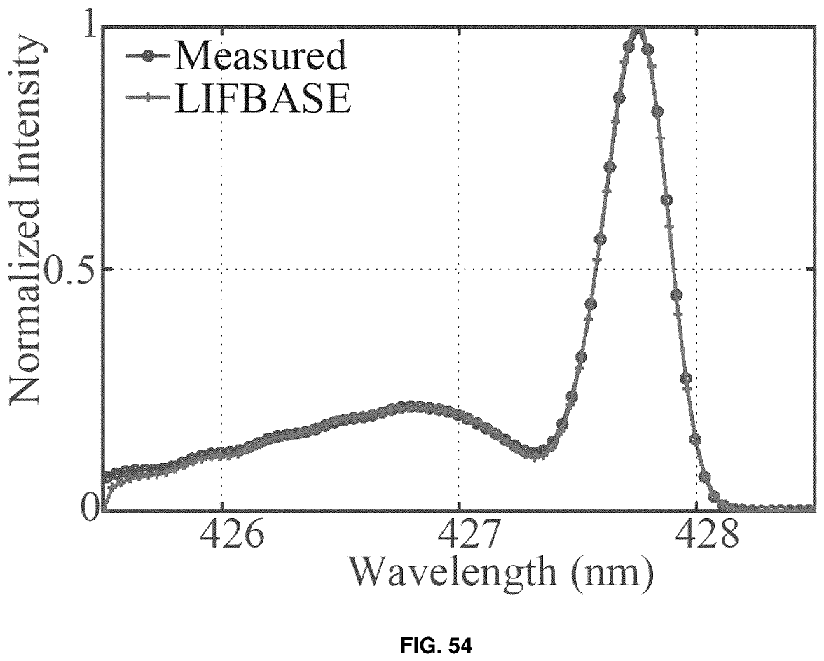

Important parameters governing the usability of a plasma jet for various applications include characteristics such as gas temperature and electron density. To ensure the safety of the plasma jet, it is important to maintain a temperature close to room level. In this context, the plasma discharge temperature was characterized by evaluating the rotational gas temperature for diatomic molecules N₂⁺. To achieve this, optical emission spectroscopy (OES) was employed, utilizing a highresolution optical sensor to capture the spectral profile of N₂⁺ molecules over a 10-second duration. Subsequently, the experimentally obtained profile was compared with the spectrum generated by LIFBASE for N₂⁺ molecules. By comparing the two spectral profiles, the discharge temperature was accurately calculated with a ±5 K precision. As an illustration, for an input power of 15 watts and a gas flow rate of 5 slpm, the experimental and simulated profiles are juxtaposed in FIG. 54, showcasing an excellent alignment between the two profiles at a temperature of 350 K. The gas temperature remains at 315 K for an input power of 5 W and rises to 350 K at an input power of 15 W. This temperature range ensures the device's safety for temperature-sensitive applications, such as plasma medicine.

Determining the gas temperature makes it possible to characterize the electron density of the anapole plasma jet. To achieve this, optical emission spectrometry is employed to analyze spectral profiles. Among the commonly utilized spectral profiles in this context are the spectral emissions of hydrogen atoms, specifically Balmer-alpha (H-α) at 656.279 nm and Balmer-beta (H-β) at 486.135 nm, due to their visibility in the spectrum and distinct linear Stark effect. In this study, the H-α lines were employed for estimating the electron density (nₑ), as they offer greater distinctiveness when compared to the H-β spectral profiles. A spectral profile within the atmospheric plasma jet can be described as a convolution of Gaussian and Lorentzian profiles, collectively referred to as the Voigt function. The Gaussian component of the spectral profile is influenced by factors such as the mass of the hydrogen atom, central wavelength, and gas temperature. Conversely, the Lorentzian component, which is more dominant, encompasses Doppler, van der Waals, and Stark broadening effects. It is important to note that resonance broadening due to interactions between neutral atoms of the same kind, while present, is typically negligible for Balmer lines at atmospheric pressure and can, therefore, be disregarded. The remaining three broadening mechanisms are accurately considered when assessing the electron density. Doppler broadening, for instance, arises when emitting atoms exhibit random motion, and the full width at half maximum can be determined as:

$$Δ {λ}_{D} = {λ}_{0} ( 8 ln 2 \frac{{K}_{b} {T}_{g}}{{m}_{a} {c}^{2}} )$$

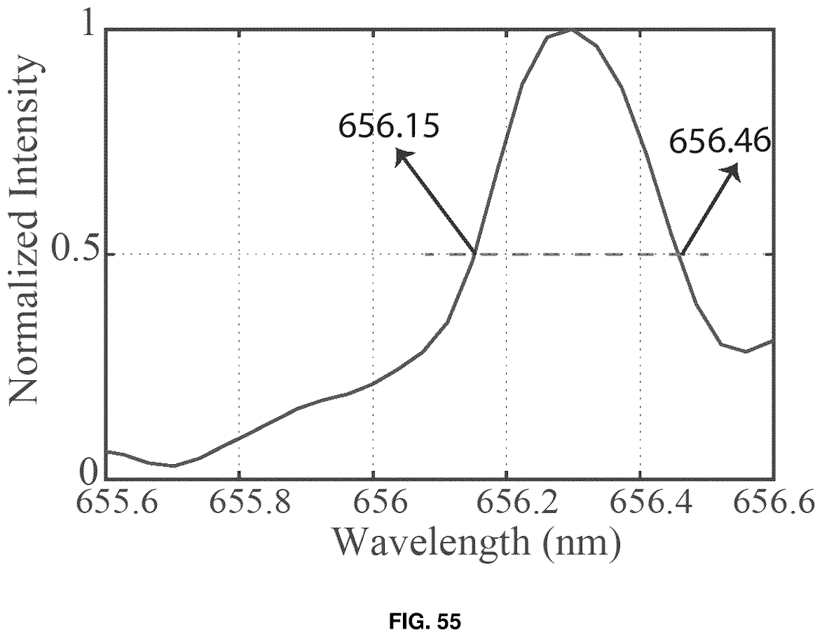

Here, the gas temperature T_{g} is in Kelvin, Boltzmann's constant K_{b} is in JK⁻¹, and ma denotes the mass of the emitter. Van der Waals broadening, on the other hand, arises due to interactions between atoms of different species and can be estimated as:

$$Δ {λ}_{vdW} = \frac{C}{{T}_{g}^{0.7}}$$

where C is a gas constant equal to 2.42 for helium. The Doppler and van der Waals broadenings are calculated using the above formulas for a gas flow rate of 5 slpm under various input powers, along with the corresponding measured temperatures. Furthermore, the full width at half maximum (FWHM) of the H-α spectral line is determined from FIG. 55. It is noteworthy that Δλ_{D} and Δλ_{vdW} are found to be very small when compared to the FWHM of H-α, indicating that Stark broadening is the dominant profile. Consequently, the electron density of the plasma jet is estimated using Stark broadening as:

$${n}_{e} = 1 {0}^{17} \times {( Δ {λ}_{Stark} / 1.098 )}^{1.47135}$$

Here, nₑ is in cm⁻³, and λ_{Stark} is in nm. The evaluated ne is approximately 1.55×10¹⁶ cm⁻³, at least twice the values typically achieved in conventional plasma jets employing resonant cavity approaches.

The interaction between a plasma jet and the surrounding ambient air holds significant potential for generating highly reactive species, including OH, NO, NO₂, O, and O₃, among others. These reactive species have garnered considerable interest for their applicability in medical and agricultural contexts. The production of these reactive species is intricately linked to the specific attributes of the plasma jet, such as the background gas composition, the rate of gas flow, and the method employed to generate the plasma jet. For example, as demonstrated in, microwave plasma jets can yield substantial quantities of desirable NO species. The frequency of operation plays a pivotal role in influencing the production of a diverse array of reactive species. However, it is important to note that the characteristics associated with frequency remain underexplored, mainly owing to the complex nature of microwave plasma jet technologies. Recent developments in low power operated plasma jets have significantly enhanced the accessibility of plasma sources for generating and utilizing reactive species within the microwave frequency range. However, these technologies are primarily built around cavities with electric fields confined within metallic enclosures, making frequency-tunable operations complex.

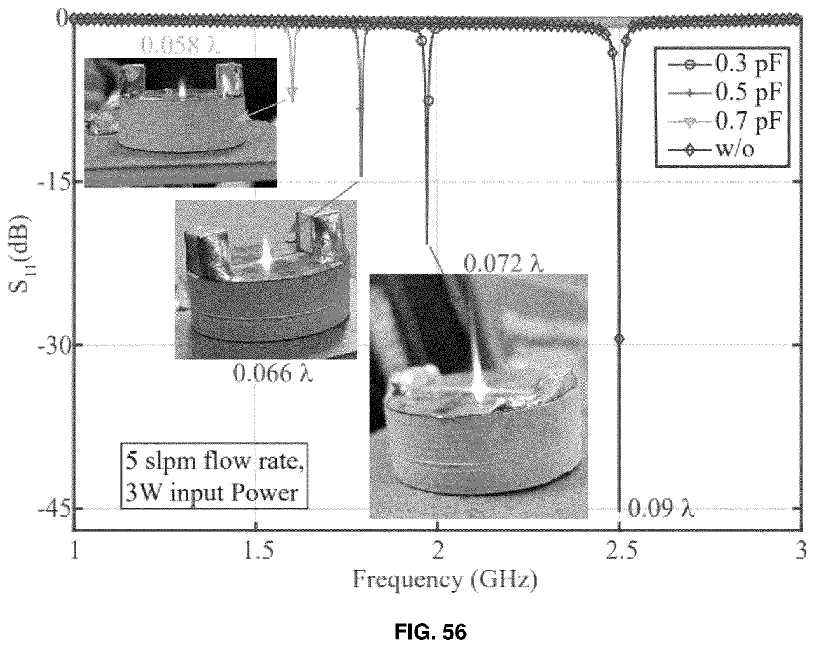

The anapole device in this example is designed as an open cavity featuring an accessible electric field for frequency tunability. As depicted in FIG. 56, this tunability is achieved by using two capacitors positioned at the edges of a tapered slot on the dielectric disk. By varying the capacitance within the range of 0.3 to 0.7 pF, the system achieves an impressive tuning capability, spanning nearly 900 MHZ, with frequencies ranging from 2.5 GHZ (no capacitor) to 1.6 GHz in the presence of the 0.7 pF capacitors.

This design facilitates tunable operation within a broad frequency range, spanning from 1.6 GHz to 2.5 GHz, offering a 900 MHz bandwidth. To validate this concept, three devices were successfully demonstrated, each operating at different frequencies: 1.6 GHz, 1.8 GHZ, and 1.97 GHz. In each case, a plasma jet was generated using a 5-slpm flow rate of Helium with only 3 W of input power, highlighting the low-power operation of the system. Furthermore, adjusting the same design to a lower frequency of 1.6 GHz while maintaining the exact dimensions emphasizes its compactness, enabling scalability and facilitating seamless integration with microwave sources.

This example successfully demonstrates a fully planar, compact, and frequency-tunable atmospheric pressure plasma jet device. This plasma jet technology leverages the capabilities of a dielectric anapole structure, a non-radiating resonator, to enhance the near electric field while effectively suppressing far-field radiation. Some key advantages of the anapole device include its high electron density, compact form factor, seamless integration capability, and cost-effectiveness.

### Example 3

### Anapole Plasma Line

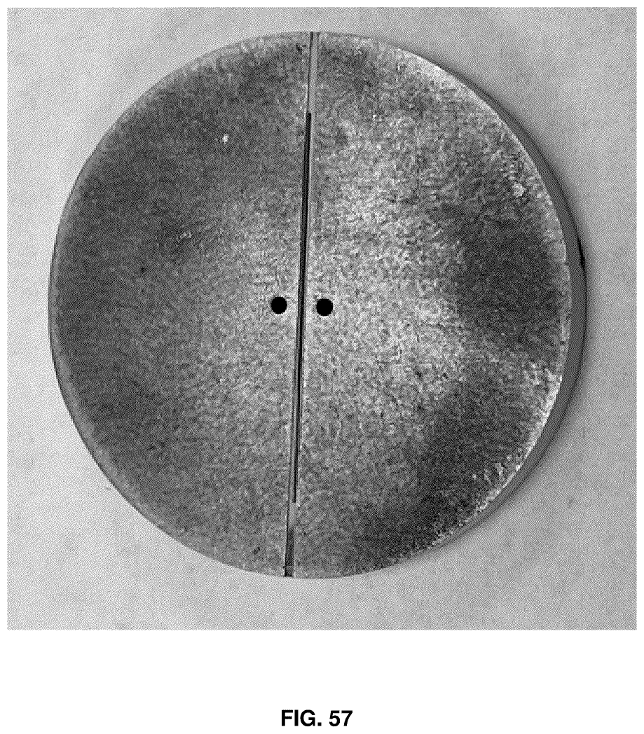

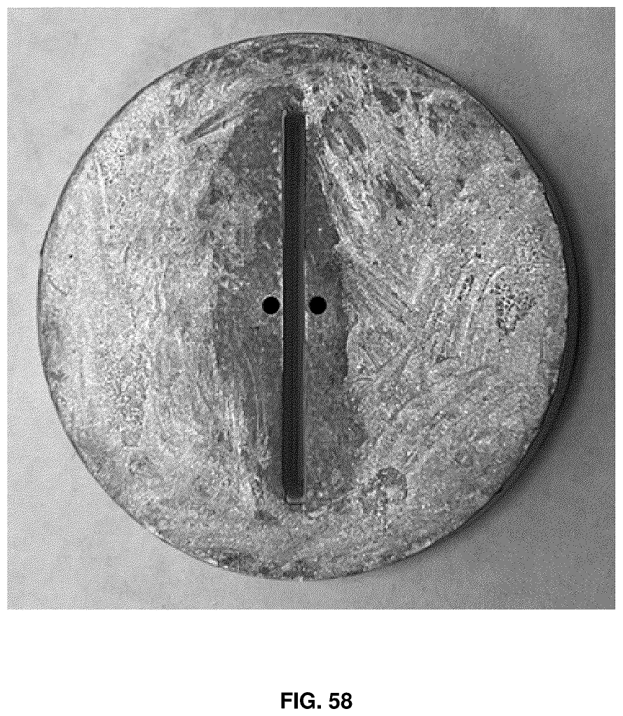

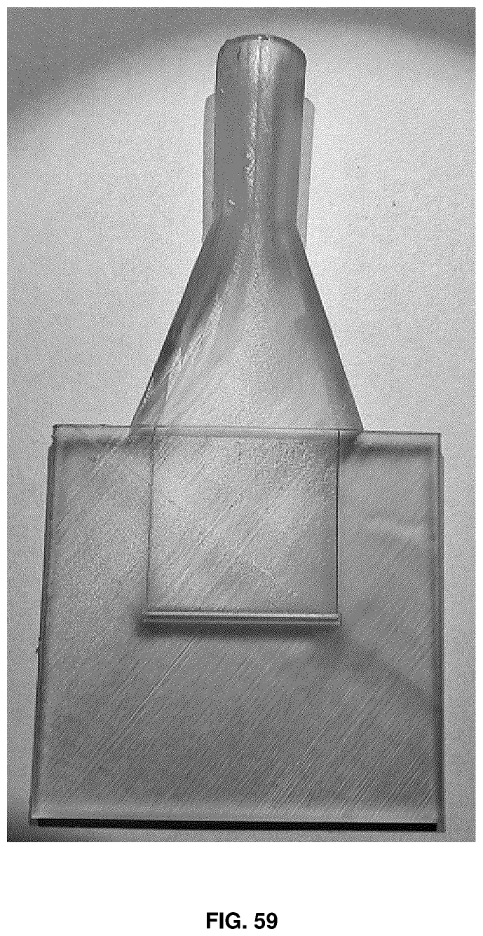

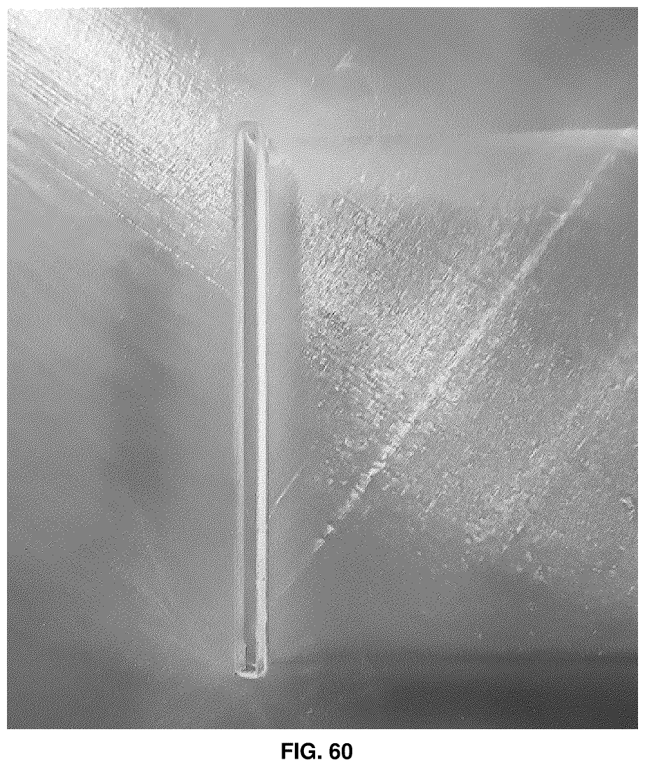

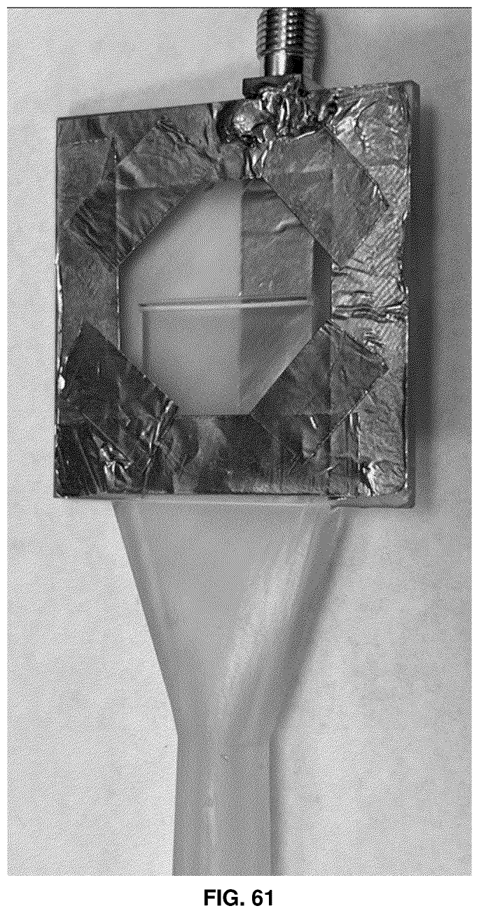

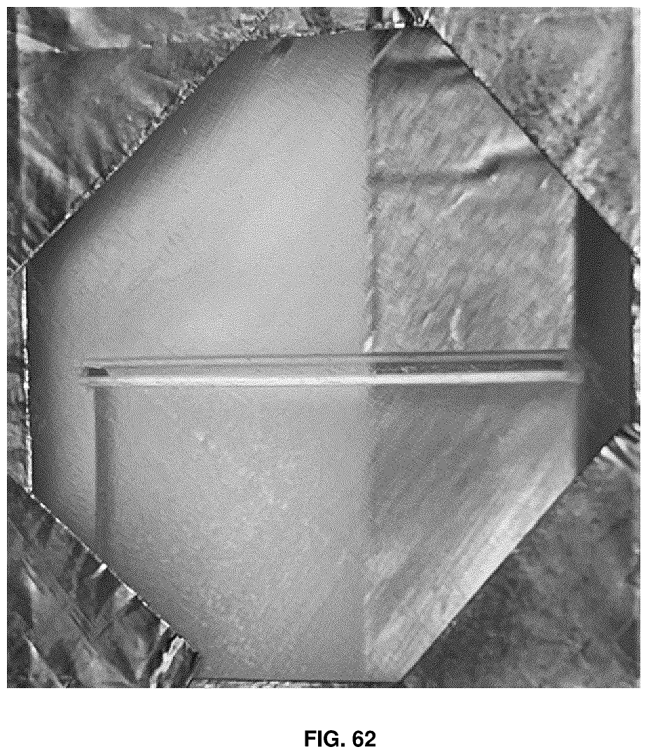

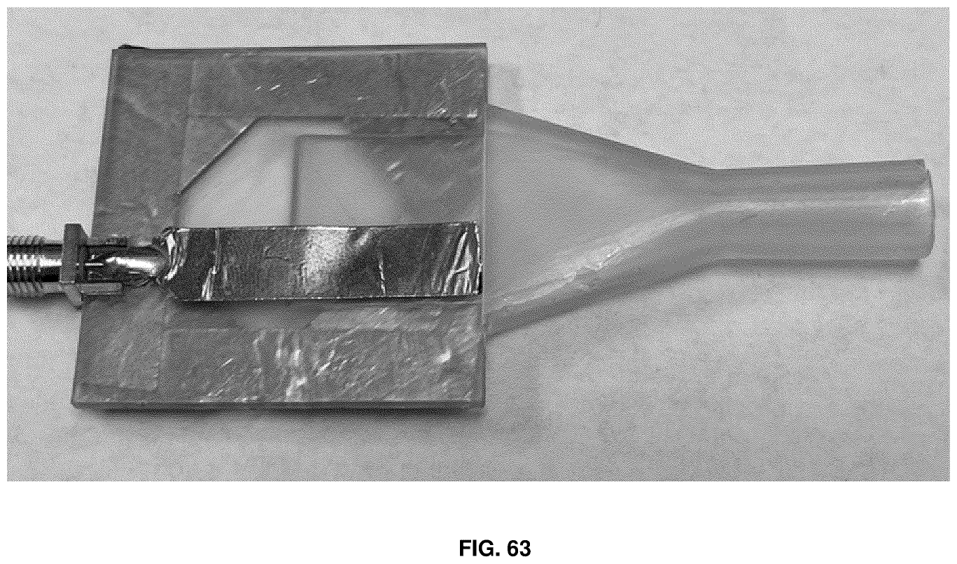

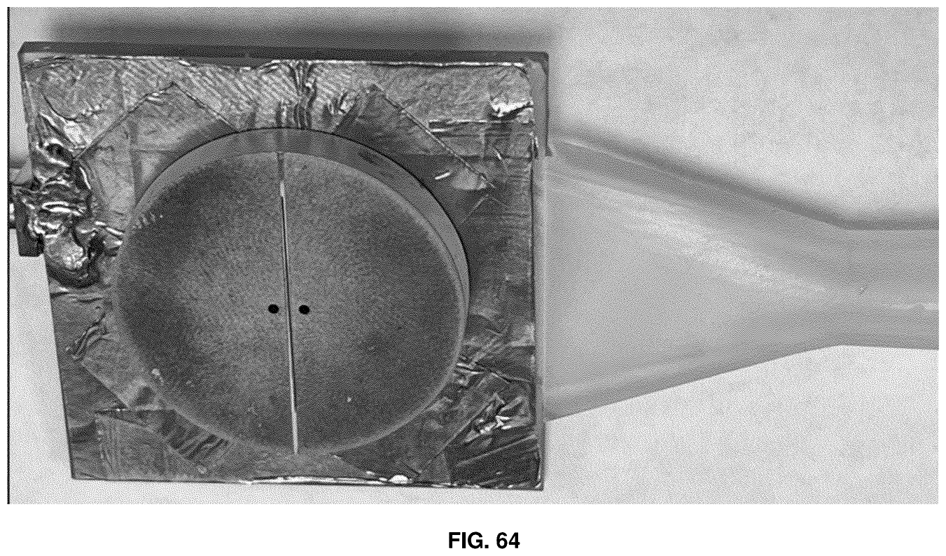

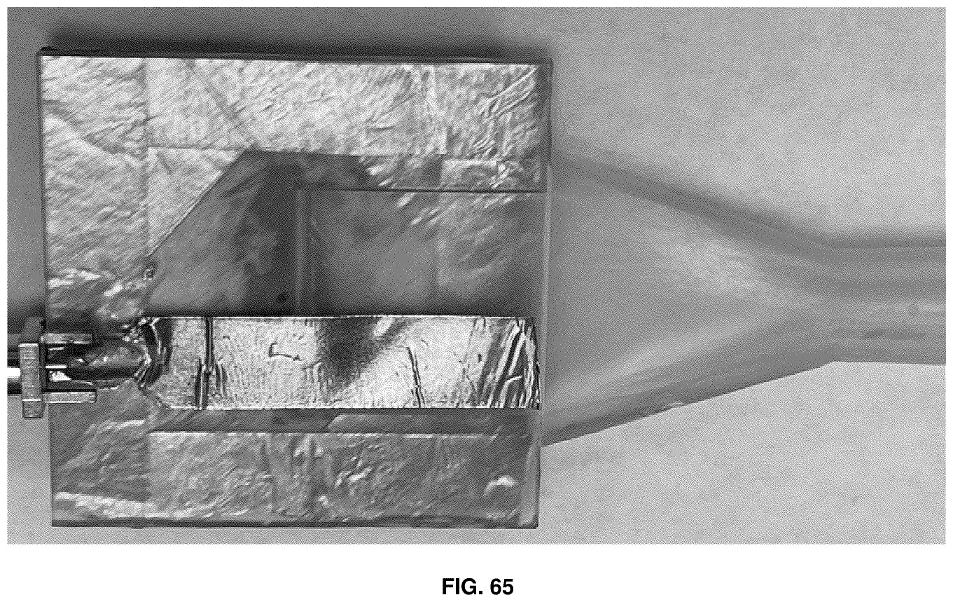

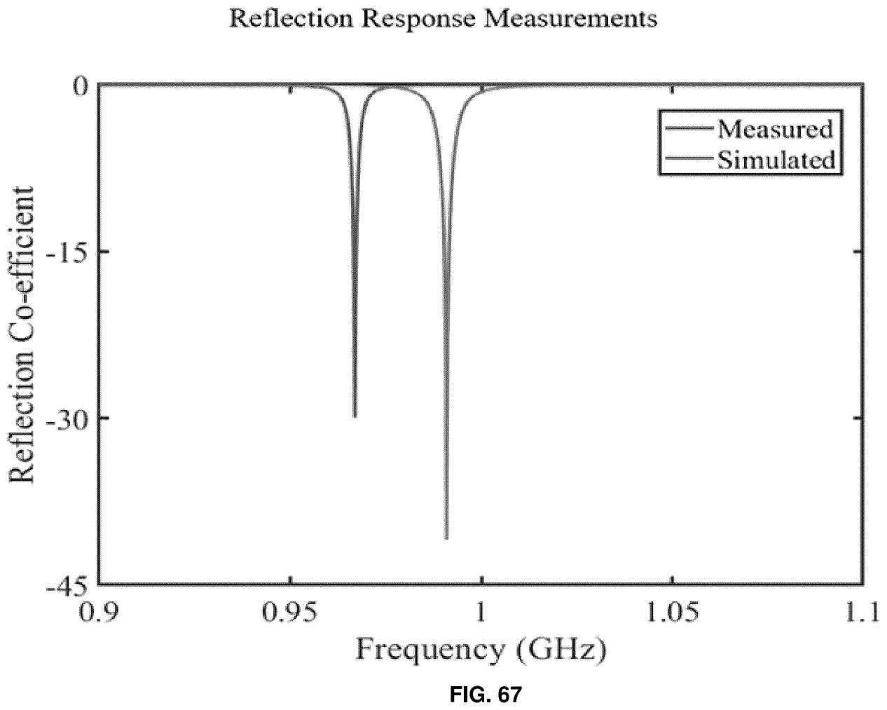

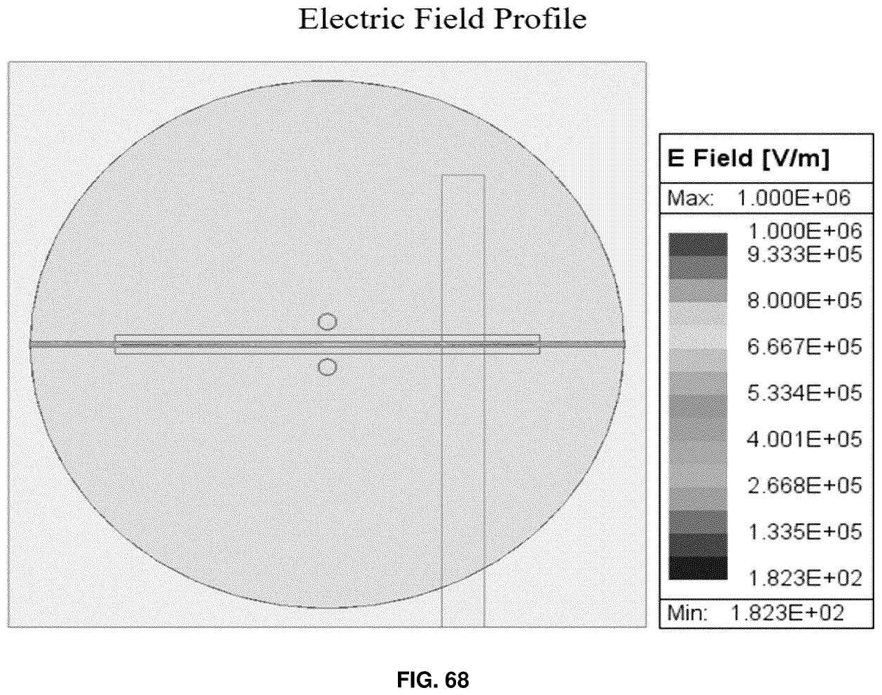

An anapole plasma line assembly was made with an anapole resonator composed of TMM13I laminate that has a channel formed through the device. The channel was 1 mm by 20 mm with depth of 3 mm from the bottom side of the anapole resonator. The channel from the top side was 0.1 mm by 20 mm which open joins the bottom slot as seen in FIGS. 57-58. The feeding board was made of high temperature resin from the FORMLAB by using a 3D printer. The gas flow channel was introduced with circular inlet that has an inner diameter of 6 mm to an outlet of a rectangular channel of 20 mm, as seen in FIGS. 59-60. Copper tape was used to develop the microwave feeder to the anapole resonator as seen in FIGS. 61-63. The anapole resonator was then fixed over the feeding board in such a way that the bottom slot was inserted right on top of the feeding board as in FIGS. 64-65. An SMA connector was used to feed the microwave energy to the resonator and gas was fed through the inlet using a mass flow controller. The reflection performance of the device was evaluated numerically and experimentally indicated near 100% microwave energy coupling with the device at the resonant frequency around 970 GHz as shown in FIGS. 67-68. The electric field at the slot region goes as high as 1×10⁶ V/m, ensuring the low power operation of the device. The uniform line plasma jet over the whole 20 mm line can be seen in FIGS. 69-71. The anapole plasma line assembly produced the uniform line plasma jet using around 6 W of power at lower flow rate i.e., 1-3 slpm and around 25 W of power at high flow rate i.e., 30 Slpm or higher. The background gas was helium, but the jet can be realized with any gas.

Certain embodiments of the devices and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices and methods described herein to various usages and conditions. Various changes may be made, and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A plasma jet assembly comprising:
a dielectric substrate having a first surface and a second surface opposite the first surface;
a first metallic layer disposed on the first surface of the dielectric substrate;
a second metallic layer disposed on the second surface of the dielectric substrate;
a first conductor extending through the dielectric substrate from the first metallic layer to the second metallic layer;
a second conductor spaced apart from the first conductor, the second conductor extending through the dielectric substrate from the first metallic layer to the second metallic layer;
a recess formed in the first metallic layer between the first conductor and the second conductor;
the second metallic layer having a means for coupling electromagnetic radiation to the dielectric substrate between the first conductor and the second conductor; and
a jet passageway formed through the first metallic layer and the first surface of the dielectric substrate.

2. The plasma jet assembly of claim 1, wherein at least one of the first conductor and the second conductor includes a via hole formed through the dielectric substrate.

3. The plasma jet assembly of claim 1, wherein at least one of the first conductor and the second conductor includes a metallic member formed through the dielectric substrate.

4. The plasma jet assembly of claim 1, wherein the means for coupling electromagnetic radiation includes a substrate channel formed in the second metallic layer.

5. The plasma jet assembly of claim 2, further comprising a feeding board having a first side and a second side, the first side having a feeding board channel corresponding to the substrate channel, and the second side having a planar transmission line configured to feed electromagnetic energy to the dielectric substrate through substrate channel and the feeding board channel, wherein the second surface of the dielectric substrate is disposed over the first side of the feeding board so that the substrate channel and the feeding board channel align.

6. The plasma jet assembly of claim 1, further comprising a first capacitor and a second capacitor disposed over the first surface of the dielectric substrate, wherein the first capacitor is adjacent to an edge of the recess, and wherein the second capacitor is adjacent to an opposite edge of the recess.

7. The plasma jet assembly of claim 1, wherein the jet passageway is a circular hole.

8. The plasma jet assembly of claim 1, wherein the jet passageway is a rectangular slot formed within the recess.

9. The plasma jet assembly of claim 8, wherein the means for coupling electromagnetic radiation includes a substrate channel formed from the second metallic layer towards the first metallic layer.

10. A plasma jet assembly comprising:
a dielectric substrate having a first surface and a second surface opposite the first surface;
a first metallic layer disposed on the first surface of the dielectric substrate;
a second metallic layer disposed on the second surface of the dielectric substrate;
a first conductor extending through the dielectric substrate from the first metallic layer to the second metallic layer;
a second conductor spaced apart from the first conductor, the second conductor extending through the dielectric substrate from the first metallic layer to the second metallic layer;
a recess formed in the first metallic layer between the first conductor and the second conductor;
a substrate channel formed from the second metallic layer towards the first metallic layer between the first conductor and the second conductor; and
a jet passageway including a rectangular slot formed within the recess and through the first metallic layer and the first surface of the dielectric substrate.

11. The plasma jet assembly of claim 10, wherein at least one of the first conductor and the second conductor includes a via hole formed through the dielectric substrate.

12. The plasma jet assembly of claim 10, wherein at least one of the first conductor and the second conductor includes a metallic member formed through the dielectric substrate.

13. The plasma jet assembly of claim 10, further comprising a feeding board having a first side and a second side, the second side having a planar transmission line configured to feed electromagnetic energy to the dielectric substrate through the substrate channel.

14. The plasma jet assembly of claim 10, further comprising a first capacitor and a second capacitor disposed over the first surface of the dielectric substrate, wherein the first capacitor is adjacent to an edge of the recess, and wherein the second capacitor is adjacent to an opposite edge of the recess.

15. A plasma jet assembly comprising:
a dielectric substrate configured to act as a split ring resonator and concentrate electromagnetic energy at a position adjacent to a jet passageway formed through the dielectric substrate;
a source of electromagnetic energy coupled to the dielectric substrate; and
a gas source configured to supply gas to the jet passageway.

16. The plasma jet assembly of claim 15, further comprising a first metallic layer disposed on a first surface of the dielectric substrate and a second metallic layer disposed on a second surface of the dielectric substrate.

17. The plasma jet assembly of claim 16, further comprising a first conductor extending through the dielectric substrate from the first metallic layer to the second metallic layer; and a second conductor spaced apart from the first conductor, the second conductor extending through the dielectric substrate from the first metallic layer to the second metallic layer.

18. The plasma jet assembly of claim 15, further comprising a first capacitor and a second capacitor disposed over a first surface of the dielectric substrate, wherein the first capacitor is adjacent to an edge of a recess formed through the first surface of the dielectric substrate, and wherein the second capacitor is adjacent to an opposite edge of the recess.

19. The plasma jet assembly of claim 15, wherein the jet passageway is a circular hole.

20. The plasma jet assembly of claim 15, wherein the jet passageway is a rectangular slot.
